(19) United States
(12) Patent Application Publication
(10) Pub. No.: US 2016/0225063 A1
(43) Pub. Date: Aug. 4, 2016

(54) SYSTEM AND METHOD FOR USING CROWDSOURCED PERSONALIZED RECOMMENDATIONS

(71) Applicant: Sears Brands, L.L.C., Hoffman Estates, IL (US)

(72) Inventor: Kelly Joseph Wical, Monticello, IN (US)

(21) Appl. No.: 15/010,891

(22) Filed: Jan. 29, 2016

Related U.S. Application Data
(60) Provisional application No. 62/109,877, filed on Jan. 30, 2015.

(51) Int. Cl. G06Q 30/06; G06F 17/22

(52) U.S. Cl. CPC G06Q 30/0631; G06F 17/2247; G06Q 30/0641

(57) ABSTRACT

A system and method for providing personalized recommendations or promotional information to consumers based upon a recommendation algorithm selected from a number of recommendation algorithms, by matching personal contextual information of each consumer to detailed contexts in which each recommendation algorithm exhibits optimal performance.

### CROSS-REFERENCE TO RELATED APPLICATIONS/INCORPORATION BY REFERENCE

The present application makes reference to, claims benefit of, and claims priority to U.S. Provisional Patent Application No. 62/109,877, filed Jan. 30, 2015, which is hereby incorporated herein by reference, in its entirety.

### FIELD

Aspects of the disclosure relate to systems and methods that generate product or service recommendations to consumers. More specifically, certain aspects of the present disclosure relate to systems and methods for providing maximally effective personalized recommendations or promotional information to consumers based upon automatic selection of recommendation algorithms most likely to result in consumer purchase of recommendations selected from a number of recommendation algorithms, by matching personal contextual information of each consumer to detailed contexts in which each recommendation algorithm exhibits optimal performance

### BACKGROUND

Promotional information and product or service recommendations are directed at consumers based upon a limited amount of information about the consumer. Frequently, recommendations are made and promotional materials are selected based upon simply demographics such as household income, zip-code, age, or gender. For that reason, such recommendations and promotional information are frequently off-target and not applicable or of interest to the consumer.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and method for providing personalized recommendations or promotional information to consumers based upon a recommendation algorithm selected from a number of recommendation algorithms, by matching personal contextual information of each consumer to detailed contexts in which each recommendation algorithm exhibits optimal performance, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is an illustration of exemplary computer network in which a representative embodiment of the present disclosure may be practiced.

FIG. 2 is a diagram showing the intersection of optimization, customer, and business, in accordance with aspects of the present disclosure.

FIG. 3 is an illustration of an example detail user interface screen of a system supporting the use of crowdsourced or single-submission personalized recommendations, in accordance with various aspects of the present disclosure.

FIG. 4 shows an example consisting of five tests involving different test versions and strategies, in accordance with various aspects of the present disclosure.

FIG. 5 shows a diagram illustrating the basic process that each test may go through, in accordance with various aspects of the present disclosure.

FIG. 6 is an illustration of an example web page user interface for evaluating test performance contexts, in accordance with various aspects of the present disclosure.

FIG. 7 shows a table illustrating an example set of “Allocation Types” and associated weights for use in version optimization, in accordance with various aspects of the present disclosure.

FIG. 8 is an illustration of an example test listing web page of a user interface of a system according to various aspects of the present disclosure.

FIG. 9 is an illustration of an example test system detail web page, in accordance with various aspects of the present disclosure.

FIG. 10 is an illustration showing detailed information corresponding to the measures listed in the right part of FIG. 9, in accordance with various aspects of the present disclosure, as described above.

FIG. 11 is an illustration showing an expanded view of the left part of FIG. 9, in accordance with various aspects of the present disclosure.

FIG. 12 is an illustration showing an example Test Results Dump and Report Screen, in accordance with various aspects of the present disclosure.

FIG. 13 is a table containing example dimensions that may be used for contextual optimization, and corresponding weights, in accordance with various aspects of the present disclosure.

FIG. 14 shows a table showing “Profit PUM” for a “Vertical” category of “Appliances”, accordance with various aspects of the present disclosure.

FIG. 15 is a table showing “Profit PUM” for the “Cold-Start” case for a “51-100” bucket, in accordance with various aspects of the present disclosure.

FIG. 16 is an illustration of confidence related measures that may appear in, for example, the middle portion of FIG. 9, in accordance with various aspects of the present disclosure.

FIG. 17 is an illustration to aid in understanding an example calculation of the “Probability B Outperforms A” measure, in accordance with various aspects of the present disclosure.

FIG. 18 is a flowchart of an exemplary method for providing personalized recommendations or promotional information to consumers based upon a recommendation algorithm (all or part) selected from a number of recommendation algorithms, by matching personal contextual information of each consumer to detailed contexts in which each recommendation algorithm exhibits optimal performance in some context, in accordance with a representative embodiment of the present disclosure.

### DETAILED DESCRIPTION

Aspects of the disclosure relate to systems and methods for providing product or service information to consumers. More specifically, certain aspects of the present disclosure relate to systems and methods for providing personalized recommendations or promotional information to consumers based upon a recommendation algorithm selected (all or in part) from a number of recommendation algorithms, by matching personal contextual information of each consumer to detailed contexts in which each recommendation algorithm exhibits optimal performance.

The following description of example methods and apparatus is not intended to limit the scope of the description to the precise form or forms detailed herein. Instead the following description is intended to be illustrative so that others may follow its teachings.

The terms “merchant” and “sponsoring merchant/merchants” may be used herein to refer to the owner and/or operator of a business enterprise that operates either or both of traditional “brick-and-mortar” business locations or an e-commerce or social e-commerce platform as described herein, or enters into an agreement with another to operate such a platform on their behalf.

The terms “customer,” “consumer,” “end-user,” and “user” may be used herein interchangeably to refer to a potential or existing purchaser of products and/or services of a merchant or business.

The term “social network” may be used herein to refer to a network of family, friends, colleagues, and other personal contacts, or to an online community of such individuals who use a website or other technologies to communicate with each other, share information, resources, etc. The term “social graph” may be used herein to refer to a representation of the personal relationships or connections between individuals in a population.

The term “follow” may be used herein to refer to a user request to be kept informed about a particular person, place, or thing.

The term “share” may be used herein to refer to a user request to communicate information about what is being viewed by a user to members of the user's family, friends, or social network.

The term “tag” may be used herein to refer to a label (e.g., a string of characters) attached to or associated with someone or something for the purpose of identification or to give other information (e.g., characteristics of the person or thing, category to which the person or thing belongs, a relationship to other persons or things).

The term “e-commerce” may be used herein to refer to business or commerce that is transacted electronically, as over the Internet.

The term “social e-commerce” may be used herein to refer to e-commerce in which consumers interact with other consumers socially as part of e-commerce activities. Merchants or businesses may take part in social e-commerce by engaging consumers in various activities including, by way of example and not limitation, email messaging, text messaging, games, and posting or monitoring of activities and information exchanged on social networking platforms (e.g., Facebook®) and/or merchant supported social networks.

The term “crowdsourcing” may be may be used herein to refer to the practice of obtaining needed services, ideas, or content (e.g., information) by soliciting contributions from a large number of sources. The terms “crowdsource” and “crowdsource population” may be used herein to refer to a large number of sources from which contributions of services, ideas, or content may be solicited.

The term “personal contextual information” may be used herein to refer to information associated with or about an individual and their life situation including, by way of example and not limitation, name, residence location or address, residence climate, type of residence (e.g., single family home, apartment, condominium), gender, age, personal income, purchase history (e.g., at one or more merchants), credit history, credit card information, Internet activity (e.g., e-commerce and/or social e-commerce activity, page selection, page viewing, purchases, searches), social network membership and/or activity (e.g., sharing, following, tagging, friending), current geographic location, social graph, personal preferences, personal interests, personal behaviors and activities, hobbies, education, marital status, military status, and information about family members.

As utilized herein, the terms “exemplary” or “example” means serving as a non-limiting example, instance, or illustration. As utilized herein, the term “e.g.” introduces a list of one or more non-limiting examples, instances, or illustrations.

The disclosed methods and systems may be part of an overall shopping experience system created to enhance the consumer shopping event. For example, the disclosed system may be integrated with the customer's reward system, the customer's social network (e.g., the customer can post their shopping activity conducted through the system to their social network), digital/mobile applications, shopping history, wish list, location, merchandise selections, or the like. However, the system disclosed may be fully and/or partially integrated with any suitable shopping system as desired, including those not mentioned and/or later designed.

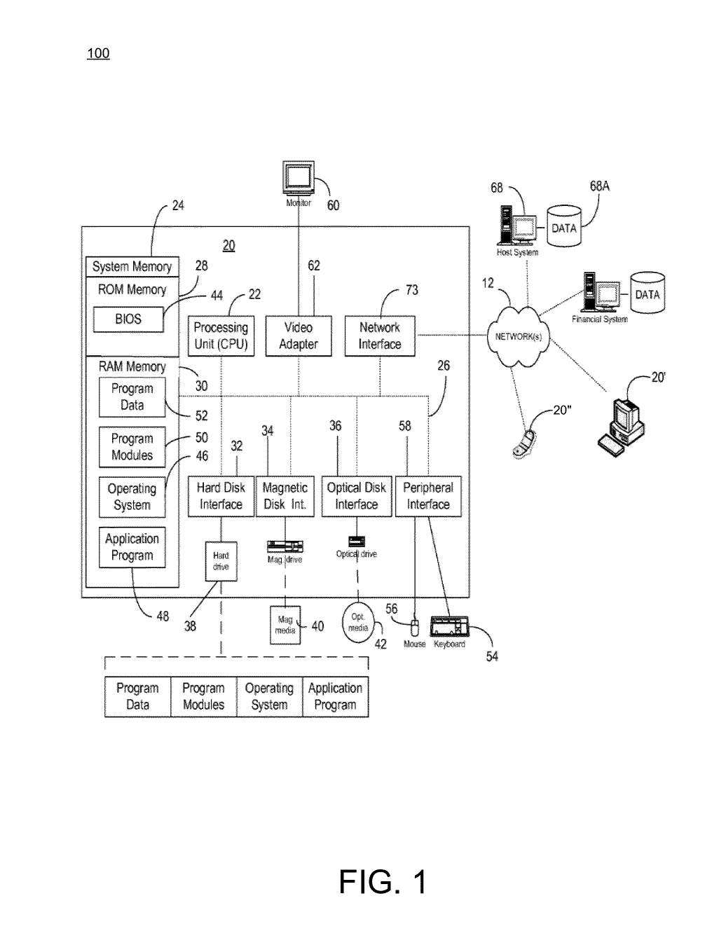

FIG. 1 is an illustration of exemplary computer network 100 in which a representative embodiment of the present disclosure may be practiced. The following discloses various example systems and methods for, by way of example and not limitation, for providing personalized recommendations or promotional information to consumers based upon a recommendation algorithm selected from a number of recommendation algorithms according to personal contextual information of each consumer. Referring now to FIG. 1, a processing device 20″, illustrated in the exemplary form of a mobile communication device, a processing device 20′, illustrated in the exemplary form of a computer system, and a processing device 20 illustrated in schematic form, are shown. Each of these devices 20, 20′, 20″ are provided with executable instructions to, for example, provide a means for a customer, e.g., a user, a customer or consumer, etc., or a sales associate, a customer service agent, and/or others to access a host system 68 and, among other things, be connected to a content management system, an electronic publication system, a hosted social networking site, a user profile, a store directory, and/or a sales associate. Generally, the computer executable instructions reside in program modules which may include routines, programs, objects, components, data structures, etc. that perform particular tasks or implement particular abstract data types. Accordingly, the processing devices 20, 20′, 20″ illustrated in FIG. 1 may be embodied in any device having the ability to execute instructions such as, by way of example, a personal computer, mainframe computer, personal-digital assistant (“MAI cellular telephone, tablet computer, e-reader, smart phone, or the like. Furthermore, while described and illustrated in the context of a single processing device 20, 20′, 20”, the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices are typically connected to the processing unit 22 by means of an interface 58 which, in turn, is coupled to the bus 26. Input devices may be connected to the processor 22 using interfaces such as, for example, a parallel port, game port, FireWire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system 68 having associated data repository 68A. In this regard, while the host system 68 has been illustrated in the exemplary form of a computer, the host system 68 may, like processing device 20, be any type of device having processing capabilities. Again, the host system 68 need not be implemented as a single device but may be implemented in a manner such that the tasks performed by the host system 68 are distributed amongst a plurality of processing devices/databases located at different geographical locations and linked through a communication network. Additionally, the host system 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services (e.g., system running recommendation algorithms), systems of shipping/delivery companies, media content providers, document storage systems, etc.

For performing tasks as needed, the host system 68 may include many or all of the elements described above relative to the processing device 20. In addition, the host system 68 would generally include executable instructions for, among other things, coordinating storage and retrieval of documents; maintaining social network storage of a shopping list; receiving a location of a customer via a mobile device; maintaining maps and layouts of buildings and geographic areas; calculating directions or routes within buildings and geographic areas; searching, retrieving, and analyzing web-based content; managing operating rules and communication with user devices used by participants in a multiplayer consumer game, for receiving a request for a service call center connection from either a customer or a sales associate; routing a received request via a distributed mobile video call center; receiving questions from individuals seeking information, distributing the questions to a targeted audience, and returning suitable answers to the requestor; and providing a service call infrastructure for providing the requestor with a distributed customer service experience, and providing personalized recommendations or promotional information for consumers as described further herein.

Communications between the processing device 20 and the host system 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, program modules depicted relative to the processing device 20, or portions thereof, may be stored in the non-transitory computer-readable memory storage device(s) of the host system 68 and processing devices 20, 20′ and 20″.

Every day merchants make numerous changes in how they interact with their customers, e.g. changing the wording of marketing messages in an email campaigns, repositioning products on a home page, modifying algorithms for recommendations on a product detail page, deciding what products in what quantity to place in what stores, and many other aspects of their customer interfaces.

A system in accordance with aspects of the present disclosure, which may be referred to herein by the acronym “SPAN,” addresses a number of issues that may arise when contemplating changes in how the merchant interacts with their customers. For example, how does the merchant know that every piece of data and/or each experience presented to a customer is helpful instead of harmful to the goals of the merchant, and will such presented data and experiences keep working towards the goals of the merchant as time, products, customers, and contexts change day by day? Making arbitrary changes to various aspects of the customer experience because merchant staff prefer one choice over another is highly subjective, and no one is likely to be qualified to make correct predictions all of the time. The merchant could test a number of different ways of interacting with a customer, and the merchant may believe that they have selected the best choices via, for example, A/B or MV testing. The merchant may find, however, that every one of the different ways really accounted for the ‘best’ way to interact with each particular customer, depending on the customer and the immediate context of the customer, and only the correct use of all ways of interacting actually yield the most profitable results.

Second, how can the merchant be certain that every customer will react the same way in any given context? The interaction with each customer may be very different and involve different techniques, eliminating the simplistic idea that a single AB test that does not consider the unique contexts of each customer could best determine how something should be done.

Third, how can the merchant make the best use of information from the wide mix of internal and external companies and groups that offer recommendation algorithms having contrastive functionality and data, to create an optimal matrix that determines what recommendation techniques/algorithms/data work best for each customer in each consumer context?

A system according to the present disclosure is designed to help a merchant to understand what is happening in a complex test of various recommendation algorithms, consumer contexts, and multiple dimensions of data, from the perspective of achieving the goal(s) (e.g., financial goals) of the merchant, to understand how to influence each customer in the way most likely to achieve the merchant goal(s), and to maintain this understanding going forward.

In accordance with aspects of the present disclosure, this approach is accomplished using what may be referred to herein as a “Designed Experiment”. Randomized experimentation is in part more commonly known as “A/B testing”. Every part of every web page/widget/recommendation/mobile page/email campaign, etc. may be deeply instrumented with many financial metrics and many dimensions of data being driven by many different data-sets and algorithms from many different sources (e.g., both from those internal to the merchant, and from 3^{rd} party companies, for example).

In accordance with aspects of the present disclosure, different test strategies may be formed that will determine the best financial performance for every different data dimension. In this way, every change may be test-proven and every subsequent decision may then be data-supported. The selected results may then be based on the personalized information about each customer, tied to the overall goals (e.g., financial goals) of the merchant. A system according to aspect of the present disclosure may form an ‘optimization matrix’ of algorithm/data+customer+business+functionality+behavior+context, and may let a merchant see the ‘matrix’ and work with it.

Beyond testing and determining which recommendation algorithm works best in terms of specific financial measures (which may be different by business unit or management areas of a merchant), a system according to the aspects of the present disclosure has the capability to contextualize and personalize every customer interaction and put every data point into a dimension matrix, thus comparing the results not just at a global level, but at different contextual and behavioral levels. In other words, based on the test results, a system according to aspects of the present disclosure is able to report data observations such as, for example, “This message may work better for an Apparel business on customers who do not purchase very frequently”, or “This ad layout may work better for Holidays when the weather is very mild”, or “This test version may work better for those products that have very few sales.” The system of the present disclosure may then create new strategies that will route the traffic based on this knowledge and the specific consumer context and verify whether these new possibilities work as expected. Once the initial test metrics have been accumulated, all of the different customer contexts are evaluated and the version that performs best in each customer context is identified as the optimized version for that customer context. Then, when a customer clicks and a request (i.e., customer traffic) is made, the contextual specifics of that customer are extracted and matched against the optimized version, determining which version should supply the recommendation for this customer at this time. Such practice, i.e. using the best recommendation algorithm option in every possible consumer context, may be referred to herein as “Contextual Optimization”.

Because the optimization according to aspects of the present disclosure is based on a comprehensive collection of financial measures and data dimensions, many factors, especially each customer's personal interests; preferences; actions; and activities; the context in which they occur (e.g., the area of the country where the customer is located, the weather for the customer location, special marketing event times, etc.); and what the customer is presently doing (e.g., information tracking the website behavior of the customer), will all be taken into account when choosing among different customer interaction options. In this way, each customer's personalized shopping experience will emerge and enable the merchant to configure systems that will allow recommendations generated by a system according to the present disclosure to interact properly with the customer.

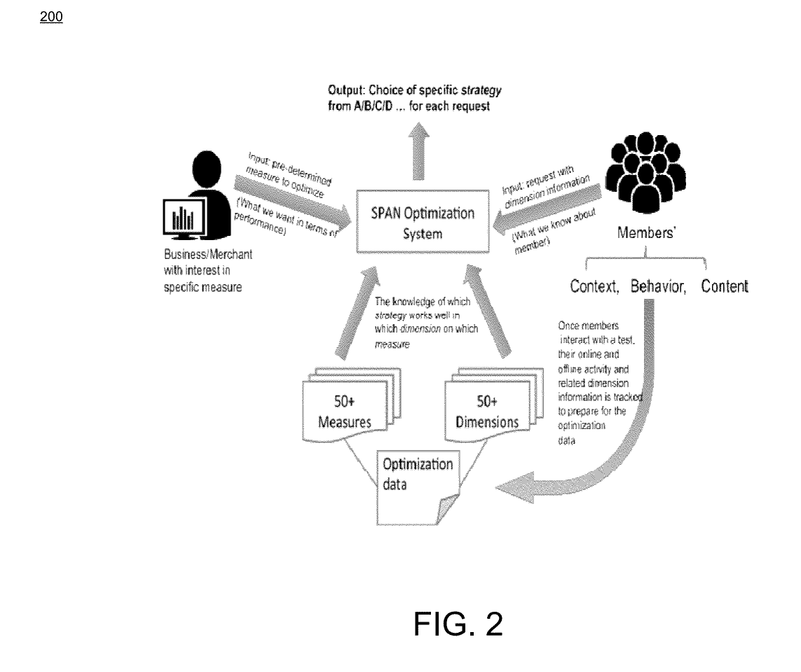

FIG. 2 is a diagram showing the intersection of optimization, customer, and business, in accordance with aspects of the present disclosure. Aspects of the present disclosure support incorporating contributions of 3^{rd} parties to provide contrastive functionality (e.g., data and algorithms), allowing the merchant to define, at various levels of granularity, the financial objective(s) that are to be optimized by the system making decisions based on customer information and prior testing knowledge. The testing-optimization-personalization process itself is a learning experience for both the system and for the merchant users of the system. Based on what the merchant learns, the merchant will be able to improve the potential options and augment their systems using rich and sound evidence provided by aspects of a system of the present disclosure. Various aspects of the present disclosure involve the integration of multiple recommendation algorithm and data sources (e.g., from 3^{rd} party companies and groups internal to the merchant) into a system in accordance with the present disclosure.

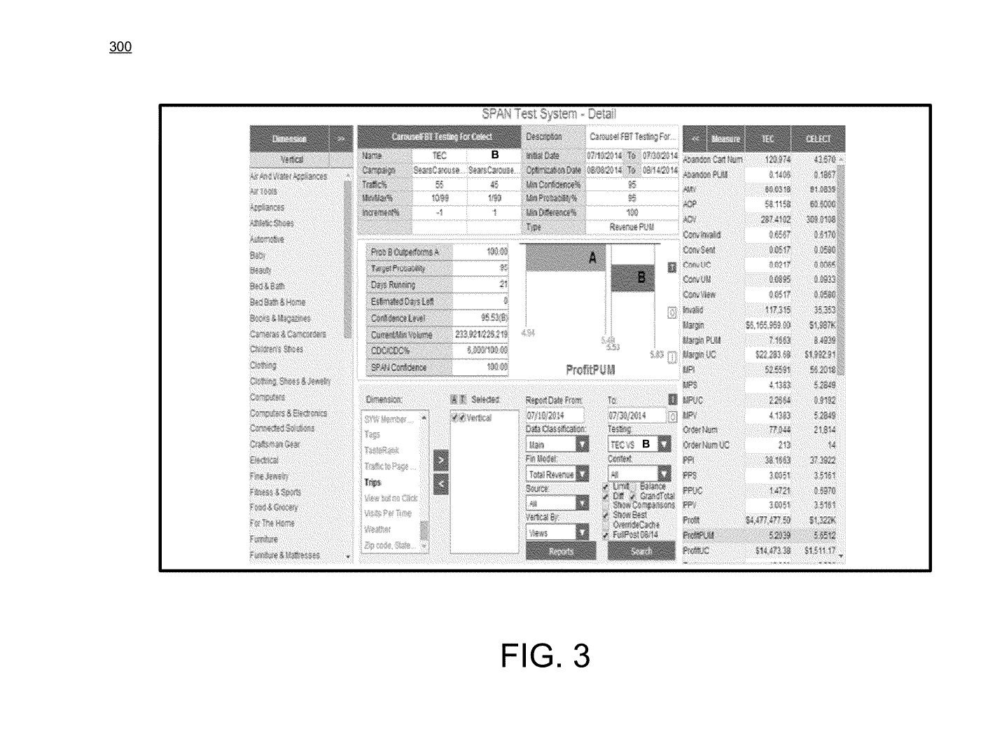

FIG. 3 is an illustration of an example detail user interface screen 300 of a system supporting the use of crowdsourced or single-submission personalized recommendations, in accordance with various aspects of the present disclosure. A system in accordance with aspects of the present disclosure implements what may be referred to herein as Matrix Context Personalization (MCP) Testing, which may be regarded as an enhanced A-B/Multi-Variant/Multi-Page/Interactions testing toolkit. The user interface screen 300 shows various aspects of the testing environment user interface. A more detailed explanation of how various aspects of the system of the present disclosure works is discussed below. It should be noted that each strategy can represent a version, and that the terms “version”, “strategy”, and “strategy version” may be used herein to refer to one of the parts being tested (e.g., the A, B, C . . . side of the test). The term “strategy” may be used to refer to a merchant or human interpretation of what is going to be done, and when it is set up to run as part of a test version may then best refer to each of the test participants. Note that the term “test” may be used herein to refer to the overall test being conducted, which is made up of a number of strategies or versions that may be provided by any party, whose recommendation algorithms and/or data are integrated into the system of the present disclosure, including external 3^{rd} party providers.

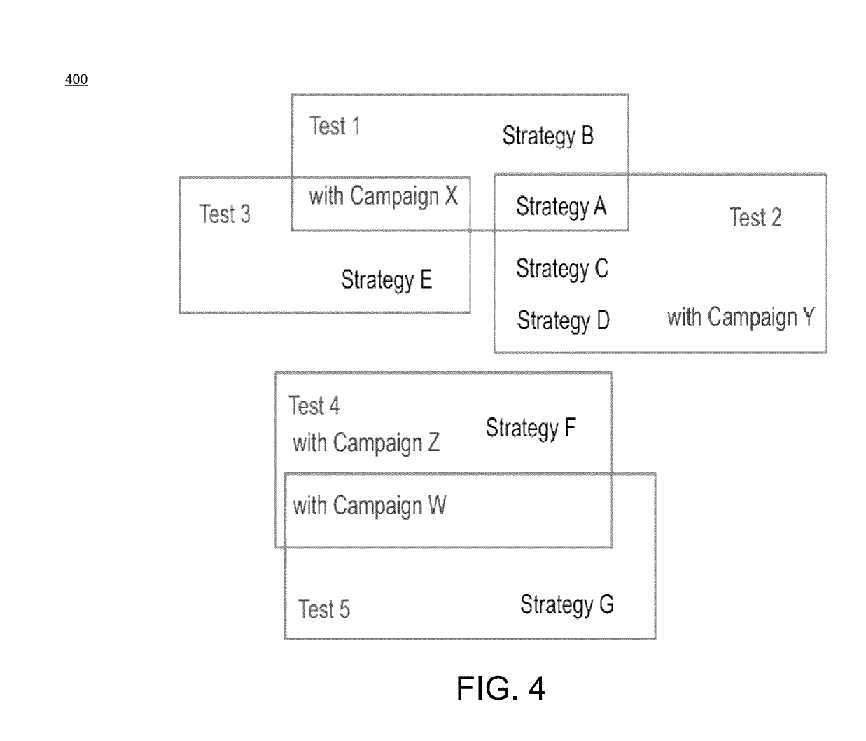

FIG. 4 shows an example consisting of five tests involving different test versions and strategies, in accordance with various aspects of the present disclosure. The term “strategy” may be used herein to refer to specific designs of how a merchant may interact with customers such as, for example, a specific technique used to make product recommendations or to choose layouts used in communications or interactions with customers such as, for example, emails, web pages, etc. When a test strategy is constructed, the integration with other elements such as, for example, configurations and missing data fill-ins etc. may override basic strategies, so the actual strategy applied to customers might be more complex than one simple design.

In the example of FIG. 4, “Test 3” has two strategies competing with each other. It should be noted that in the illustration of FIG. 4, a “control group” is used, but is hidden for reasons of simplicity so that, for example, “Test 3” not only has “Strategy E,” but also implicitly has a “Strategy Zero”, a “control group”. In a traditional “A/B” Test, the original strategy version is often referred to as the “control group” (also referred to herein as the “A” side), and the proposed change strategy version may be referred to as the “experiment group” (also referred to herein as the “B” side). In the example of FIG. 4, “Test 1” and “Test 2”, separately, each have more than two strategies. When “Test 1” and “Test 2” are viewed together, however, one of the strategies may be in another different test. In the example of FIG. 4, “Test 3” refers to the overall test, of which there are two sides, “A” and “B”, which may be referred to as the “strategies”. In this example, “A” is the “control group” and “B” is the new version that will be tested against the “control group”.

A system in accordance with the present disclosure may run as many tests as needed at the same time, subject to a minimal amount of traffic (i.e., customer activity) needed to make the testing statistically valid. Testing may be campaign/carousel/page-based, meaning that each test may use a single functional area. The phrase “functional area” may be used herein to refer to any section of a web page, or any combination of web pages or parts of web pages. There is no specific limitation of the concepts of the present disclosure that require doing only one test in one area. A test may be, for example, a test to see which recommendation technique works best for selling appliances to a certain type of customer. Or a test may be, for example, a test that determines the best order of products displayed on carousels displayed on the home page for certain groups of customers. In the illustration of FIG. 4, above, “Test 1”, “Test 2”, “Test 3”, and Test 5” may be considered to be examples of “single-campaign/carousel”-type tests. In these cases, multiple tests may have an overlapping campaign/widget—as shown by the relationship “Test 1” and “Test 3”, in which “Test 1” and “Test 3” share “Campaign X.” The term “campaign” may be used herein to refer to “marketing tests” (e.g., an email “campaign”), while the term “widget” may be used herein to refer to a display area such as, for example, a “carousel” on a web page. Collectively, the term campaign/widget” may be used herein to refer to any of the functional areas or vehicles through which recommendations may be displayed to a customer. In the example of FIG. 4, “Test 4” shows that multiple campaigns/widgets in a single test may also be allowed. Such tests may overlap only with other tests that contain only one campaign, an example of which is shown in the portion of FIG. 4 in which “Test 4” and “Test 5” are together, but may not overlap with another test with multiple campaigns, to avoid possible statistical measurement issues.

A system in accordance with various aspects of the present disclosure manages traffic to balance the traffic level as desired between the different strategies, balancing at the unique customer-level. Within each test, customers that are assigned to the “A” side will always go back to the “A” side and those who assigned to the “B” (or other) side will always go back to the “B” side for the length of the test.

In accordance with various aspects of the present disclosure, when multiple tests are running at the same time, one customer may be part of multiple tests. If there are multiple tests using the same campaign/widget area, a system in accordance with the present disclosure may first manage the traffic at the test level, keeping the same customer in the same test, and then manage the traffic at the strategy level. This approach helps to ensure that the test results are valid regardless of how the tests and customers are involved. Within each test there are primarily two ways to control the traffic allocation to different sides. A first way, for example, is that the system may enable the user of the system to manually set the traffic such as, for example, split the traffic 50% to the “A” side and 50% to the “B” side, 80% to the “A” side and 20% to the “B” side, or a different suitable split that may be set or modified during a test, for example. A second way, for example, is for the system of the present disclosure to automatically adjust traffic, according to a set of guidelines, but allow the system to determine how traffic is best managed. This second way of controlling traffic allocation may be referred to herein as the “multi-armed bandit” approach, described in further detail below.

In the “multi-armed bandit” approach, the system of the present disclosure may select for each strategy a particular measure to test such as, for example, a measure referred to herein as “Orders per View”, and in other situations, such as when the test first starts, may select a different measure to test such as, for example, a measure referred to herein as “Clicks per View”. The term “view” may be used herein to refer to any result of a request made by the customer. For example, a customer may see something on a web page or screen, may “click” on that something, and that “click” may be interpreted as a request to the test, which may then return a result. The returned result may be referred to herein as a “view” (i.e., the customer had one “view” from the test). The underlying logic of a system in accordance with the present disclosure may be configured to trade off “exploitation” versus “exploration”. That is, sending progressively more customer traffic to the better alternatives (i.e., recommendation/personalization algorithms that give better results), versus sending customer traffic to alternatives in order to understand how well they may perform. A system according to various aspects of the present disclosure may use additional choices, and may employ a default that attempts to split customer traffic evenly until the system begins to determine the performance of a recommendation/personalization algorithm, and then determines whether to add or remove customer traffic according to that performance, up to certain pre-set limits.

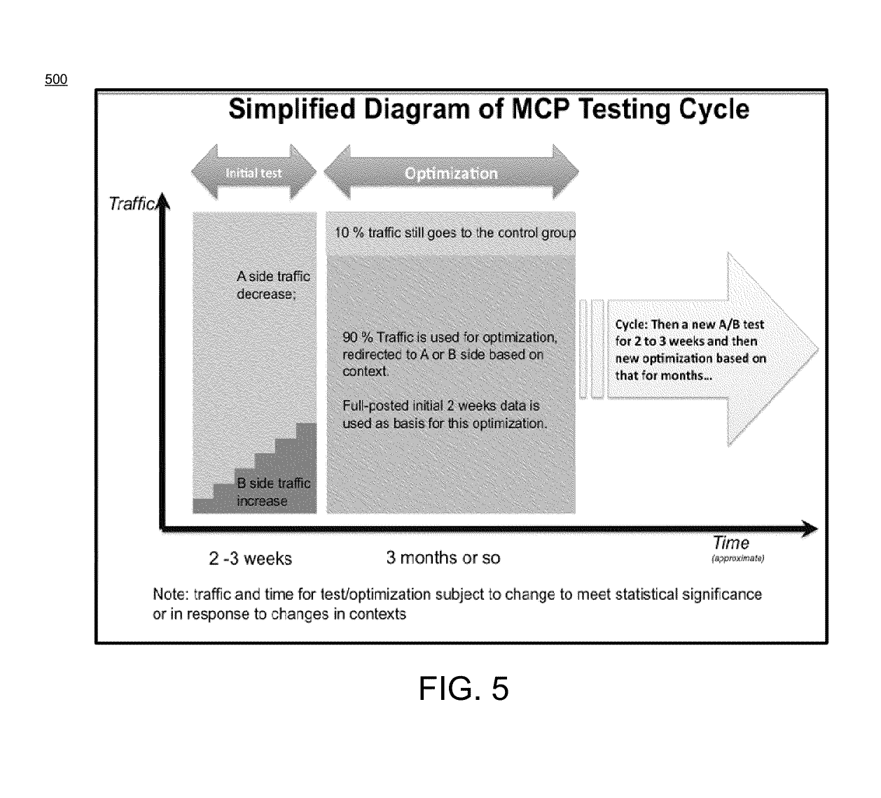

FIG. 5 shows a diagram illustrating the basic process that each test may go through, in accordance with various aspects of the present disclosure. The “A”-side denotes the base version that will be tested against (i.e., a “control group”), while the “B”-side denotes the new version. For reasons of clarity and simplicity, the diagram of FIG. 5 only shows two versions. It should be noted that the example of FIG. 5 does not represent a specific limitation of the present disclosure, but that multi-variate testing using more than two versions may be tested in the same manner, without departing from the scope of the present disclosure.

In a system according to various aspects of the present disclosure, the testing phase may be similar to traditional A/B tests, but test according to the concepts described herein also includes a metrics-generating, learning process used to generate optimization data by connecting the best data attributes in context to each customer, and subsequently a new strategy version built and tested.

In a system according to the present disclosure, the testing phase is followed by an optimization phase, which may be similar to an A/B test. As discussed above, the “A”-side may be the base strategy (or “control”) version and the “B”-side may be the optimized version. A first amount of customer traffic (e.g., 10-20%) may go only to the “control group”, as a comparison base. The remaining 80-90% of customer traffic may be routed to the new optimized version (i.e., recommendation algorithm/data) based on customer context, to achieve the best performance (e.g., financial performance). After a particular period of time (e.g., 3 months or so), a new test may be needed to update the optimization data because the customer contexts may have changed. It should be note that the optimized strategy may still be evaluated and adjusted as needed on, for example, a daily basis during this time period.

During the optimization period, the performance difference between the control (i.e., “A”-side) and the optimization (i.e., “B”-side) versions may be monitored at regular intervals of, for example, every two weeks. If it is determined that the performance of the optimization version in certain consumer contexts is significantly worse than that of the control version, the contextual optimization data may be updated and a decision of whether to re-run the initial test again may be made.

In accordance with various aspects of the present disclosure, the initial testing phases may also be optimized and integrated, though not necessarily at the same level of optimization used in the fully contextual-optimized mode, because there may be other parts in the overall system to override the final recommendations returned such as, for example, a merchant may augment recommendations of all strategies, a merchant may override recommendations of all strategies, and personalization functionality may alter recommendations on all strategies.

In accordance with various aspects of the present disclosure, strategies that yield better overall performance, such as fill-in techniques when a strategy doesn't have a recommendation, may be used to maximize performance (e.g., financial performance). This may turn any test into something more complex than the simple base test used at the start. The result may be that the merchant compares strategies to control groups, which may also be a strategy.

For this reason, the merchant may use detailed multi-touch attribution as the technique to use and pay 3^{rd} parties (if applicable), as the merchant may wish to determine what parts of which strategy relative to all recommendations is affecting the results.

It should be noted that major changes in any strategy may not be accommodated in the continuous (i.e., initial or optimized) testing phase. A system according to the present disclosure may collect the new data for a certain period of time such as, for example, approximately three weeks after changes are made. If such changes occur during the optimization phase, a new cycle may be started and changes may then be implemented to the strategies as desired.

In accordance with aspects of the present disclosure, some possible optimizations that the merchant may consider include customer behavior identification optimizations such as, for example, “Buy vs. Shop”, where interactions with the customer may be oriented towards time-savings and minimal interactions vs. more general shopping; “Precision vs. Variety”, where interactions with the customer may promote based on ideas or on more exactly what a customer may be doing; and “Preference vs. Desire” where a customer's preference may be weighed against the desire of the merchant to promote a particular “channel” such as, for example, online, omni-channel, and mobile customer interactions with the merchant.

Other systems may be integrated with a system for using crowdsourced personalized recommendations in accordance with aspects of the present disclosure, by sending a Universal Resource Locator (URL) to the system described herein instead of where the URL may normally have been sent. A system of the present disclosure may then be responsible for rendering the results using the received URL. Other possible approaches to integrating external systems with a system of the present disclosure are contemplated such as, for example, via code (e.g., via an application programming interface (API)).

A system according to aspects of the present invention may alter a received URL with tags directing any subsequent processing to work in a particular manner relative to the test strategy, and may then forward the altered URL. This approach may, however, involve an additional “browser hop”, which the merchant may wish to avoid. Therefore, a system according to the present disclosure may be primarily oriented towards testing when the system itself provides the functionality. This processing method may be most easily recognized via marketing emails and web site recommendation carousels. An additional step may extend web pages to ‘templates’ that act as the top layer of personalization, where a system according to the present disclosure may first determine what template to use (which may be the actual test level) and may then, for example, run the test at a lower carousel-type level within the template. In using emails, a system according to the present disclosure may test the entire email, a product recommendation section, or an individual item such as an offer.

For all types of integration, definitions and configurations may be managed through configuration systems that allow template definitions, carousel or campaign segment options to be established by, for example, a merchant's marketing, finance, and/or business management organizations, to define the constraints under which tests may operate, and define desired success criteria.

An important consideration is the amount of consumer traffic available for testing and optimization, and how to create the best strategy based on that customer traffic. This may be done through the use of heuristics to assess the data dimensions that the merchant instruments, and creation of a new strategy that may be used for any test type of test such as, for example, simple, multipage, template, and campaign selection that optimizes the version performance to the context of the customer, whether a 3^{rd} party or internal to the merchant.

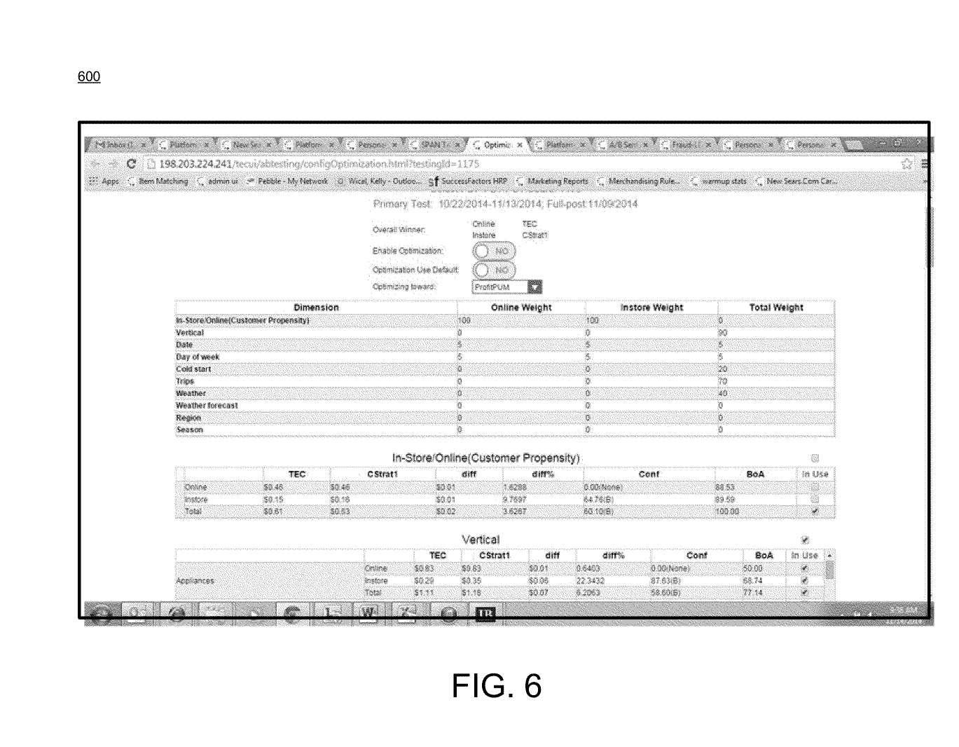

FIG. 6 is an illustration of an example web page user interface for evaluating test performance contexts, in accordance with various aspects of the present disclosure. In some instances, a system according to the present disclosure may use heuristics in place of a greater amount of consumer traffic (and subsequent metrics) that might ordinarily be used, creating a new version that connects the customer to the appropriate metrics in context. In accordance with aspects of the present disclosure, all data metrics may be built using customer data. In this manner, the actual algorithm used to create the heuristic-based strategy may itself be able to be tested against other algorithms, improving the strategy generation just like the strategy improves the individual techniques within it. Because each strategy of the system described herein may be created to tie in to personalized customer information (e.g., contexts, behavior, and preferences), the strategy is naturally personalized.

In the same way that a web site's structure may be tested from a macro level (e.g., multi-page) to more granular levels (e.g., single page, sections, carousels, or items in a carousel), so too can marketing campaigns and other types of customer interaction techniques. Marketing campaigns may be tested at the campaign level, individual sections, and isolated items as well. An overall “interactions” level may then be used to test the level above the web page and marketing campaigns. The complete set of interactions with the customer may be tested using the “Intent-Interactions” system of the present disclosure. Such a system allows for strategies to be created that test all customer interactions over a certain period of time, where recommended interactions are used on the “B”-side of the tests and the individual site carousels and marketing campaigns as they normally run are represented on the “A”-side. This allows the Intent-Interactions system to recommend each type of interaction and the time/context in which it should occur.

The goals of a merchant may vary under different situations, and data metrics in a system in accordance with the present disclosure allow for the varying needs of the merchant to be considered in selecting the types of performance results the merchant is looking for (e.g., revenue, margin, profit, conversions, clicks, etc.) while reporting the effect of the different business selections relative to profit. In accordance with some aspects of the present invention, a merchant operating a system such as that described here may base monetary payments for the use of 3^{rd} party recommendation algorithms and/or consumer data on a positive change in profitability that is linked to the use of the recommendation algorithm(s) and/or consumer data provided by such 3^{rd} parties.

In accordance with various aspects of the present disclosure, 3^{rd} party providers may provide recommendations, personalization and interaction data as part of a group or “crowd” once their algorithm(s) and/or data is loaded on a system of the present disclosure, and customer traffic is routed to them. Such 3^{rd} party providers may then be compensated based on what may be referred to herein as “Profit Lift”, which may be defined as an increase in profit seen by the merchant due to the use of the algorithm(s) and/or data of the 3^{rd} party provider over the performance of a “control group” of algorithm(s) and/or data. Such compensation may be computed on a detailed product-purchased level using a multi-touch attribution formula according to aspects of the present disclosure. This approach encourages all participants in the group or “crowd” of 3^{rd} party providers to offer the best performing algorithm(s) and/or data, because the better that the algorithm(s) and/or data perform, the more the 3^{rd} party provider makes.

Following is an example describing a list of high-level steps that may be used to compute what may be referred to herein as “multi-touch attribution” and the corresponding amount that may be paid to 3^{rd} party providers of algorithm(s) and/or data, in accordance with various aspects of the present disclosure. These steps may be performed, for example, for each item in each order that belongs to a unique customer in a test, and may be adjusted for fraud, cancellations, and returns.

First, the system of the present disclosure may compute the total “Profit Lift” brought by all of the 3^{rd} party providers of algorithm(s) and/or data. Out of the computed total “Profit Lift,” an agreed on percentage may be distributed among the 3^{rd} party providers, as computed using, for example, a formula such as the example “multi-touch attribution formula” of the present disclosure.

Next, the system of the present disclosure may compute what may be referred to herein as “Profit Allocation”, based on a formula such as the example “multi-touch attribution formula” of the present disclosure, and what may be referred to herein as a corresponding “Attribution Share Level” for each recommendation candidate.

Finally, the system of the present disclosure may use the “Attribution Share Level” as the basis to distribute the “Profit Lift” among 3^{rd} party providers as the payment for use of their algorithm(s) and/or data.

As an example, a system in accordance with various aspects of the present disclosure may use what may be referred to herein as “Profit Per Unique Member” (Profit PUM) of the control version and test versions from each test as the basis for performance lift, computing the performance improvement of each test version over the control group as a percentage, as shown below:

$$Profit PUM lift \% = \frac{Profit PUM of Experiment - Profit PUM of Control}{Profit PUM of Experiment} \times 100 \%$$

Next, the system of this example may determine what may be referred to herein as the “Profit Allocation” for each purchased item, which may be the profit for the item, and may then compute the “Profit Lift”, that is, the lift or increase with the recommendation adjusted with confidence measure, as shown below:

$$Profit Lift = \{ \begin{matrix}0 & ( \begin{matrix}if Profit PUM diff \% \leq 0 or \\ Profit Allocation < 0\end{matrix} ) \\ \begin{matrix}Profit Allocation \times \\ Profit PUM lift \%\end{matrix} & ( \begin{matrix}if 0 < Profit PUM lift \% < \\ 100 \%\end{matrix} ) \\ Profit Allocation & ( if Profit PUM lift \% > 100 \% )\end{matrix}$$

Finally, the system of the present disclosure may sum the “Profit Lift” of each line item in every test to obtain the total “Profit Lift”. It should be noted that total “Profit Lift” may need to be adjusted to remove any double counting that may occur when there are multiple tests, because there may be double counting in cases where the same customer purchase is reflected in different tests.

The “Share Level” of the present example may be computed based on the “Profit Lift”, and may be adjusted according to attribution formula factors including, for example, “clicks”, the closeness of the recommendation to the actual purchased item, an age (time) of each attribution, and other factors. For each recommendation at granular level the “Share Level” of each recommendation may be computed from the “Profit Lift” for each for each recommendation, as shown below:

Share Level=Profit Lift×Allocation Type %

Additional details are given in the following discussion on how recommendations for each line item purchased may be identified and how the corresponding “Share Level” may be computed.

A concept similar to the “Share Level” described above may be referred to as “Context Share Level”. During an “optimization phase” according to some aspects of the present disclosure, “Context Share Level” may be used instead of “Share Level” as the basis of distributing profit among 3^{rd} party providers of recommendation algorithms and/or data.

To compute “Context Share Level” in accordance with aspects of the present disclosure, a system as described herein may first compute what may be referred to herein as “Context Profit Lift”. As discussed above, “Profit Lift” may be computed based on the current phase “Profit PUM” measures. “Context Profit Lift” may only be used for the “optimization phase” of the present disclosure, and may be computed based on the preceding A/B testing phase contextual “Profit PUM” measures. The “contextual Profit PUM” may be computed in a manner similar to that of “Profit PUM”, but “contextual Profit PUM” may be limited to just the result of the contribution by the version (computed in the multi-touch attribution), instead of the entire profit amount. This is because the profit in the optimized phase is shared by all of the versions contributing recommendations.

A system in accordance with the present disclosure may identify candidate campaigns, as described below. A number of recommendations or interaction messages (e.g., marketing campaigns, offers, web page carousels, mobile recommendations, search engine marketing (SEM) links, etc.) may be sent and viewed by a customer over a period of time, before a purchase is actually made by a customer. The following is an explanation of how these recommendations may be identified along the timeline of customer interactions, and how the identified recommendations may then be selected as candidates for purchase attribution.

The process described below may be performed using all interactions made with the customer within a certain period of time prior to each purchase, when the date of the interaction being considered falls within the test period. The process may be repeated until a certain number of non-duplicate candidate interactions are selected, or until there are no more interactions available for the customer. It should be noted that the certain period of time and the certain number of non-duplicate candidate interactions may be configured by the user of the system of the present disclosure, and is not necessarily pre-set other than as, perhaps, a system default value. For example, the certain time period may be set to 30 days, but could alternately be set to 20 days or 40 days, and may have a system default of 30 days. Similarly, the certain number of non-duplicate candidate interactions may be set to a value of 30, but may alternately be set to other values, and may have a system default value.

A system in accordance with various aspects of the present disclosure may, for example, begin by accessing the most recent customer interaction prior to the time of a purchase. This interaction may be, by way of example and not limitation, a carousel the customer viewed, an email that the customer opened, an SEM link in Google that the customer clicked on, or a .COM/Mobile recommendation. If the customer interaction is a marketing campaign or an SEM link that the customer clicked on, the customer interaction is selected for purchase attribution. If the interaction is a .COM/Mobile recommendation with a “click”, the interaction is also selected for purchase attribution. If, however, the interaction is a .COM/Mobile recommendation without a “click”, any interactions occurring on the same day, but before the occurrence of the .COM/Mobile recommendation without a “click”, are searched for another recommendation with a “click”. If such an interaction is found, it is selected for purchase attribution. The process may search back a certain number of days (e.g., five days) before the purchase date to determine whether there is a marketing campaign. If there is a marketing campaign in that period, it is selected for purchase attribution. If none of the above customer interactions is found, the system performing the process may select the most recent .COM/Mobile recommendation for purchase attribution. In a system according to the present disclosure, if a customer is sent an instance of a strategy (e.g., one recommendation from one version) during a testing period, then that customer will be assigned to that version (i.e., the “B” side) and may have all of his/her purchases/orders during the testing period examined by the system.

If the merchant is what may be referred to herein as an “Omni-Channel Retailer”, that is, a retail merchant that has multiple channels through which customers interact with the merchant (e.g., both online and in-store; or online, in-store, and mail-order), not only the online orders/purchases of the customer may be tracked; but “in-store” orders/purchases may be are matched as well. An “in-store” order/purchase may, for example, show up in a Strategy test under circumstances such as when the customer did something online during the test and was assigned to a version, and the customer then (after some online interaction) purchased something during the test timeframe in a store and an identifier (ID) was recorded for that in-store purchase. In such a circumstance, the ID may be mapped to the online customer and may go through the above-mentioned process just like an online order.

A system in accordance with the present disclosure may identify top candidates and allocation types, as described below. The system according to the present disclosure may first identify what may be referred to herein as the “Allocation Type” for each campaign/carousel. An “Allocation Type” is the relationship between the recommendation or interaction and the purchased item. The relationship for each recommendation for a purchased item may be set to one of a set of the “Allocation Types”, which has an associated weight.

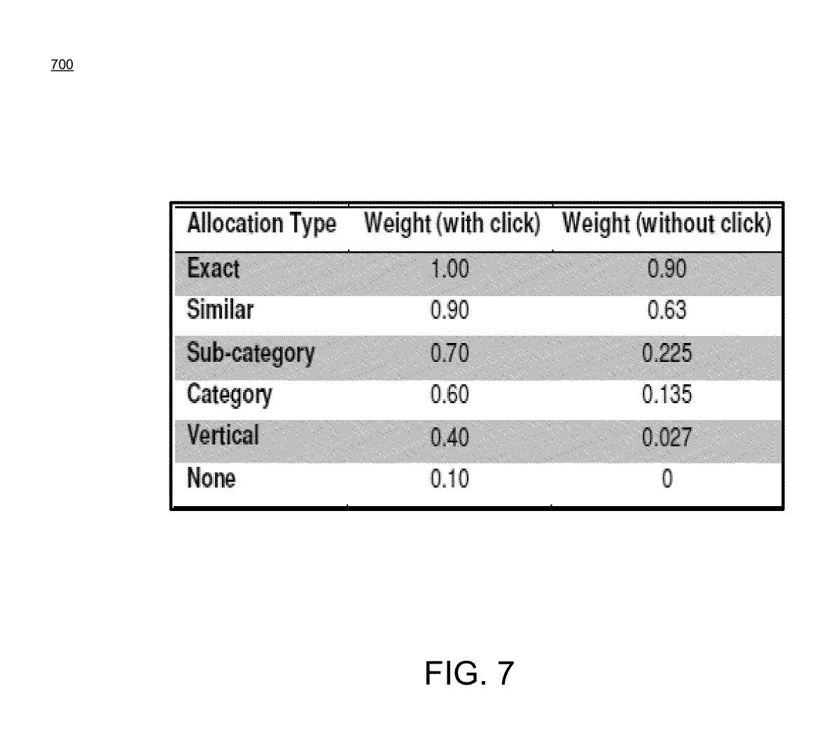

FIG. 7 shows a table illustrating an example set of “Allocation Types” and associated weights for use in version optimization, in accordance with various aspects of the present disclosure. A system according to aspects of the present disclosure may identify whether each candidate recommendation/interaction did or did not have an associated “click” and may then find the corresponding “Allocation Type” weight shown in FIG. 7. It should be noted that the values shown in FIG. 7 are example values and may change for different business contexts. Also, it should be noted that when the candidate is of “Offer” type (that is, the candidate is not product-based), the candidate may be regarded as a candidate having an “Allocation Type” that is “Exact”, as long as the specifics of the offer match the purchased item.

In addition to the relationship between the recommended/interaction item and the purchased item, the input item (e.g., parent) for recommendations may be examined to alter the “Allocation Type”. For example, when the input item matches better or equal to the purchased item being compared with the recommended item, there may be considered to be an “Input Match” allocation type, which has a weight of zero. This situation indicates that the customer may have arrived at a carousel or recommendation/interaction delivery area in some other way, and that the recommendations are not valid for attribution (i.e., through an SEM-link or an internal search) since the input item itself was reached and is equivalent to the recommendation.

The system of the present disclosure may then compute an “Allocation Type %” for each candidate recommendation/interaction using the following formula:

$$Allocation Type \% = \{ \begin{matrix}Allocation Type weight \times ( 1 - n \% ) & \begin{matrix}if {it}^{′} s a \\ marketing campaign\end{matrix} \\ Allocation Type weight \times ( 1 - 3 n \% ) & \begin{matrix}if {it}^{′} s not a \\ marketing campaign\end{matrix}\end{matrix}$$

Note that n shown above may be the number of days between the purchase/order date and the campaign date, and may be adjusted to allow more or less weight to be removed as the candidate gets older.

Next, the system of the present disclosure may find the candidate recommendation(s) with the highest “Allocation Type %”. The purchased item may be attributed equally to each item selected with this high weight.

It should be noted that additional adjustments to the attribution formula may also be made, such as using what may be referred to herein as a “U-based weighting”, which may cause the first and last candidate to add additional weight to their scores.

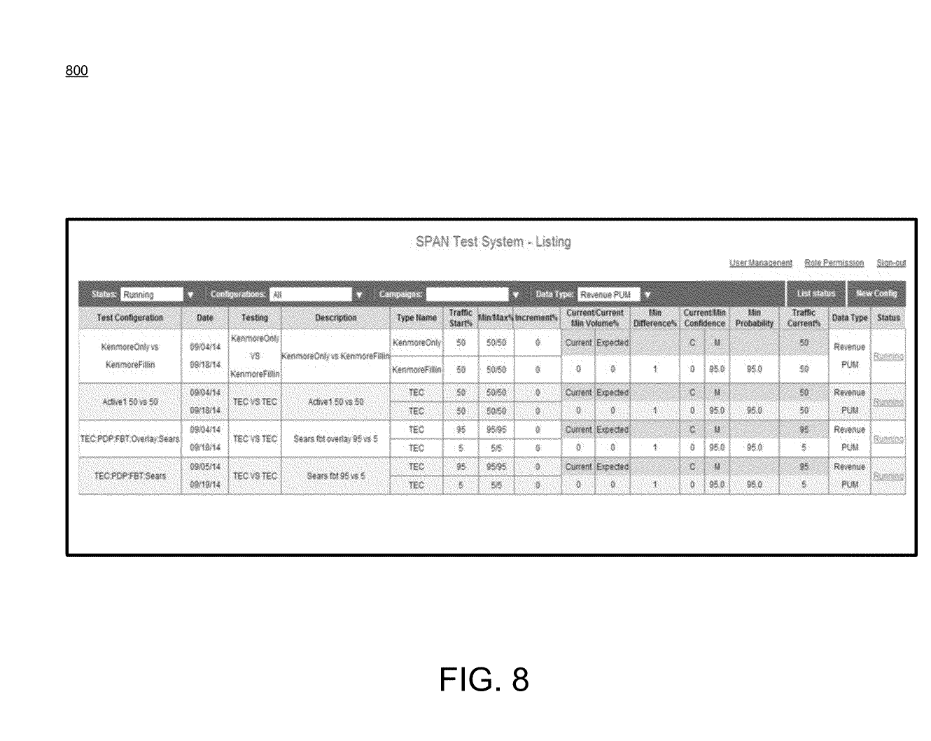

FIG. 8 is an illustration of an example test listing web page 800 of a user interface of a system according to various aspects of the present disclosure. The example test listing web page 800 shows tests based on selected criteria including a “Test Configuration” column showing the specific A/B testing; a “Date” column that shows the start and end dates of a testing period; a “Type Name” column that shows the “A” version and “B” version Strategy names; a “Traffic Start %” column that shows the initial customer traffic distribution when testing is set up; and “Max %” and “Increment %” columns that tell the system of the present disclosure how to increment or decrement traffic based on performance (e.g., multi-armed bandit and conjoint analysis based), up to a max threshold. In addition, the user of the system may click the link in the “Status” column to bring up the test detail data.

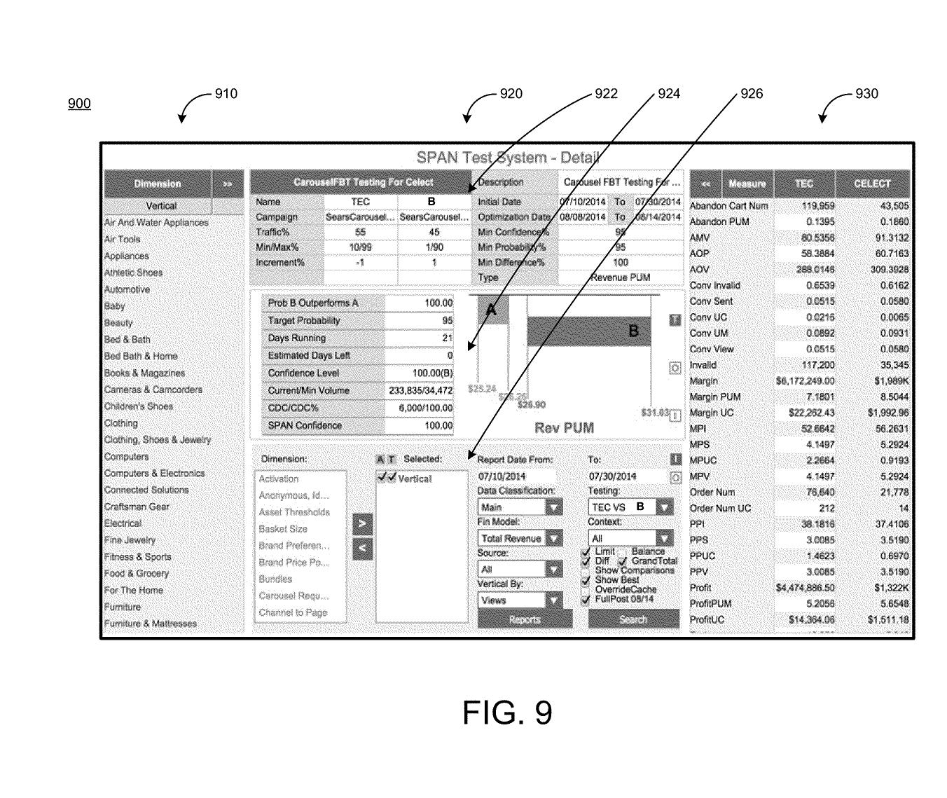

FIG. 9 is an illustration of an example test system detail web page 900, in accordance with various aspects of the present disclosure. The example detail web page 900 shows all of the metrics and dimensions for the selected test. There are three parts of the detail web page 900, a left side part 910, a center part 920, and a right side part 930. The left part 910 and right part 930 of FIG. 9 may be expanded to show additional details by clicking on/selecting the “>>” and “<<” icons at the top of the left part 910 and right part 930, respectively. The example illustrated in FIG. 9 is a default overview for a sample test according to various aspects of the present disclosure.

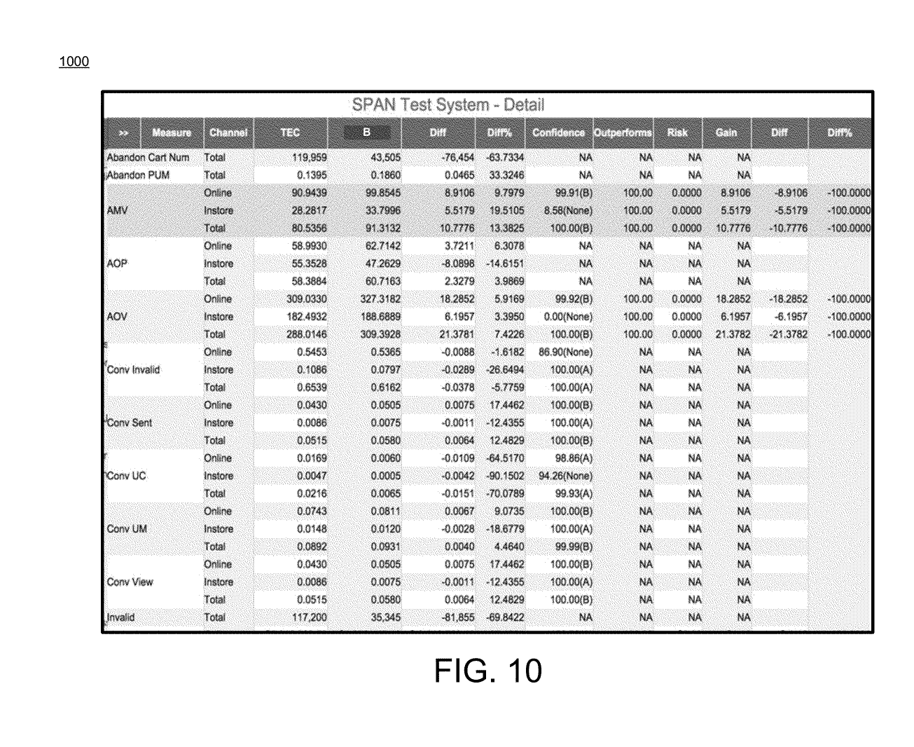

The right part 930 of FIG. 9 shows all of the financial metrics (i.e., measures) such as, for example, #Invalid, #Margin, #ProfitPUM, and so on. The statistics data in the right part 930 may not be related to any specific dimension. Instead, the statistics data in the right part 930 of FIG. 9 may be a summary for the test as a whole. If the user of the system clicks on/selects one of the measures shown in the right part 930, the system according to aspects of the present disclosure may load the detail data for that measure on the data of the center part 920 and left part 910. As mentioned above, the right part 930 of FIG. 9 may be expanded by clicking on/selecting the “<<” icon at the top of the right part 930, which produces the details shown in the example web page of FIG. 10.

The left part 910 of FIG. 9 displays the data dimension that the user of the system selects, using the results of the measure selected on the right part 930 of FIG. 9. As mentioned above, additional details about the dimensions shown in the left part 910 of FIG. 9 may be displayed through the use of the “>>” icon at the top of the left part 910.

The center part 920 of FIG. 9 has three portions. A top portion 922 displays configuration information, such as test name, campaign, the date range of the testing and Traffic %. A middle portion 924 displays the confidence intervals graph and related parameters. A bottom portion 926 displays control data, which is composed of “Dimension”; a collection of drop downs such as “Data Classification”, “Fin Model”, “Source”, “Vertical By”, “Context”; a collection of check boxes; and two buttons “Reports” and “Search”.

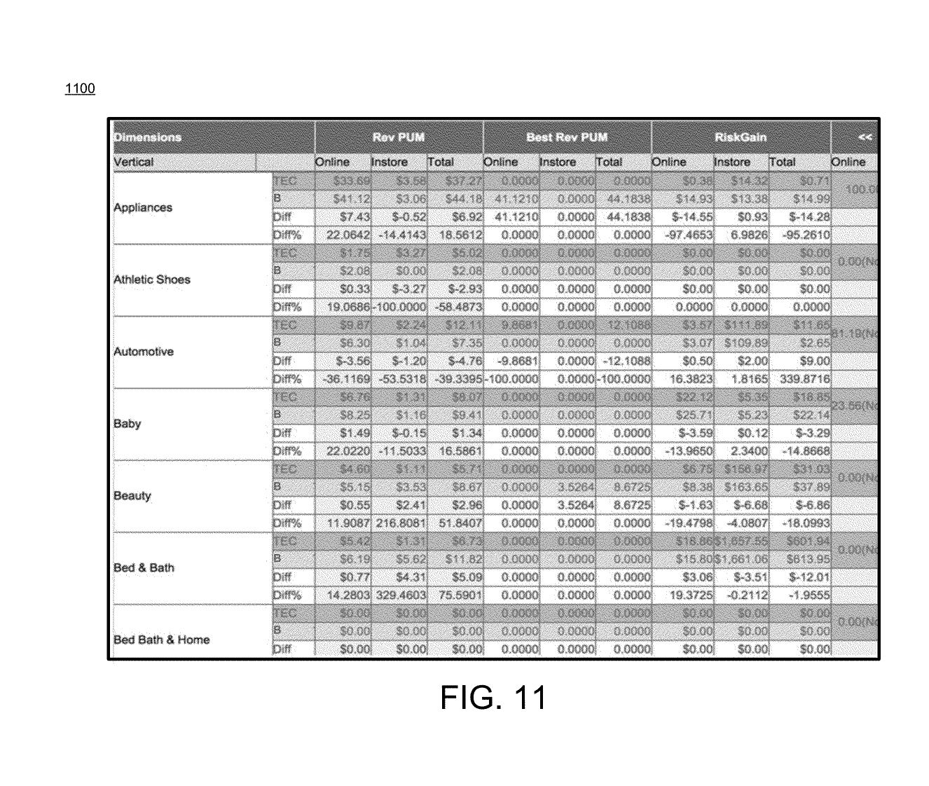

In accordance with aspects of the present disclosure, a check box such as the “Show Best” and the “Full Post” check boxes included in the bottom portion 926 of FIG. 9 may be provided. Selecting the “Show Best” check box may be reflected in the display of the details of the left part 910 of FIG. 9, as shown in FIG. 11, when the left part 910 of FIG. 9 is expanded. Extra columns shown in the expanded view of FIG. 11 such as, for example, “Best Rev PUM” (i.e., best revenue per unique member (customer)) may show the “winning side” data, when the confidence measures are satisfied. The total rows displayed in “Show Best” columns may be different from other total rows. A total row with a “base” notation may represent the predicted total when using base strategy (e.g., the “control”) only for all dimensions, while a total row with an “opti” notation may represent the predicted total when using the best-performing strategy for each dimension. This method supposes that customer traffic may be rerouted and may assume that the “per customer” and “per view” measures will be stable when scaling. In accordance with the present disclosure, one may use the percent difference between the “opti” and “base” to predict the improvement generated from conjoint analysis optimization, as compared with doing nothing. So values in “opti” may be equal to or greater than those in “base”. The optimization process of the present disclosure may use these indicators as best possible bets in what to optimize for the next test. The best outcomes may be set into the next test strategy automatically.

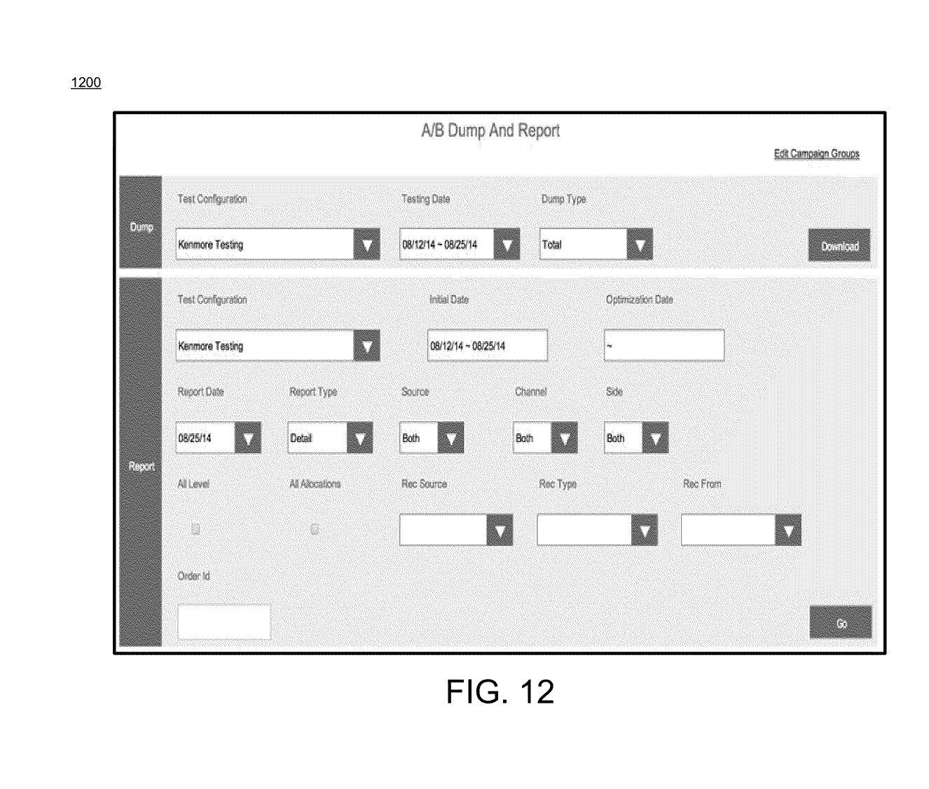

In accordance with aspects of the present disclosure, selecting the “Full Post” check box of the bottom portion 926 of FIG. 9 may control the display of data according to when the data is posted. Many measures such as, for example, “Sent”, “UM”, “TCPV”, and other may be near real-time, while purchase/order-related measures may post in near-real-time for online orders, but may post several days later for in-store purchases/orders. The user of a system in accordance with the present disclosure may choose to check this option. Once the user of the system has selected the conditions represented by the various options of FIG. 9, the user may click ‘Search’ to see the details requested. On the test system detail web page 900 of FIG. 9, the user of a system of the present disclosure may click ‘Reports’ in the bottom portion 926, to display the A/B Dump and Report Screen 1200 of FIG. 12, described below.

FIG. 10 is an illustration showing detailed information corresponding to the measures listed in the right part 930 of FIG. 9, in accordance with various aspects of the present disclosure, as described above.

FIG. 11 is an illustration showing an expanded view of the left part 910 of FIG. 9, in accordance with various aspects of the present disclosure.

FIG. 12 is an illustration showing an example Test Results Dump and Report Screen 1200, in accordance with various aspects of the present disclosure. The illustration of FIG. 12 permits a user of the system of the present disclosure to select a “Report Date”, a “Report Type”, a “Source”, a “Channel”, a “Side”, and an “Order Id” to filter the results. A system in accordance with various aspects of the present invention may, for example, support a number of types of reports including, for example, a “Detail Report” and a “Summary Report,” which may be based on order numeration, and a “Billing Report,” which may be based on recommendation statistics.

The “Detail Report” may be for a single test and a single day. Each row of the “Detail Report” may display an order in the test made on that particular date.

The “Summary Report” may be for single test, but may be for multiple days. Each row of the “Summary Report” may aggregate the data for the corresponding “Detail Report”. Grand totals may also be computed on the “Summary Report”.

The “Billing Report” may summarize each day's recommendations that are the basis for billing. Each order may have multiple purchased-items with different attached campaigns (i.e., the top candidate that's used for billing). There may also be cases of multiple campaigns attached to a single order, so the number of recommendations being examined for billing may be larger than the number of orders.

In each report page, the user of the system may also dump a Microsoft Excel file containing all the information that the report page displays.

A system according to various aspects of the present disclosure may, during the “testing phase”, split customer traffic between strategies. During the “optimization phase”, each recommendation request from the customer (i.e., when routed to a strategy that has optimizations set) may be examined and the best recommendation technique (i.e., that drove that context of the strategy) may be chosen, based on that customer's personal data, behavior and context, when known, and the business objectives (e.g. financial objectives) of the merchant. The following discusses the details of how customer traffic is redirected in the “optimization phase”. In a system according to various aspects of the present disclosure, there may be multiple levels of optimization including, for example, the forms of optimization discussed below.

A form of optimization referred to herein as “contextual optimization” may look at specific “dimensions” relative to customer data and context, and may select the best contexts for the customer's request. For example, if the customer is clicking on a product detail page of a web site, in search of a particular tool, and the customer is from a particular geographic region (e.g., the southwestern U.S.), and the customer typically purchases online, it may be that a particular strategy's recommendations best serve that context. Once all of the appropriate contextual dimensions have been selected, a system according to the present disclosure may compute scores for each strategy, using the following formula:

$$Score ( Dimension 1 , Participant A ) = \{ \begin{matrix}Profit PUM * Weight * ( BoA - 50 \% ) * 2 & \begin{matrix}if BoA is larger \\ than 50 \%\end{matrix} \\ Profit PUM * Weight * ( ( 1 - BoA ) - 50 \% ) * 2 & \begin{matrix}if BoA is not larger \\ than 50 \%\end{matrix}\end{matrix}$$

It should be noted that in accordance with various aspects of the present disclosure, the “Profit PUM” factor shown above may instead be “PPV”, or “Conversion Rate”, or any other measure as defined by the business objectives (e.g., financial objectives) of the merchant. Although “Profit PUM” is used in the example presented here, any suitable measure may be used for selecting the recommendation formula.

A system in accordance with the present invention may then accumulate each strategy's scores from the different dimensions and the test strategy (e.g., the specific context in that strategy, which may determine the actual recommendation provider) with the strongest rating in each area overall may be selected to produce the requested recommendation.

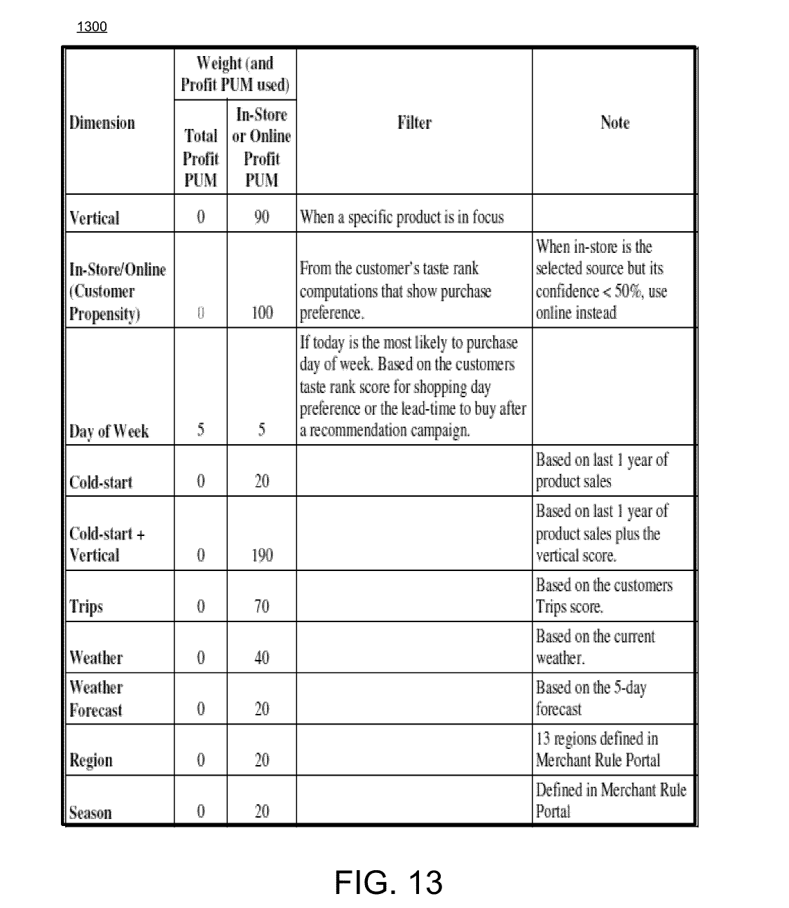

FIG. 13 is a table containing example dimensions that may be used for contextual optimization, and corresponding weights, in accordance with various aspects of the present disclosure. The illustration of FIG. 13 shows three sets of “Profit PUM” for each choice of “Dimension”, “In-store”, “Online”, and “Total”, and from the example table of FIG. 13, it can be seen that most dimensions use the in-store, online specific set, based on the customer propensity. In case there is no clear-cut data to determine a customer's propensity, the online set may be the default. In the situation in which the in-store set is selected but has a lower than 50% confidence, then the online set may be used. Anytime the online set has a lower than 50% confidence, then the total set may be used.

In a situation in which no dimensions were used due to confidence score issues, a system in accordance with the present disclosure may, by-default, use the overall winner on, for example, “Profit PUM”, or any other measure as configured).

It may be noted that 3^{rd} party providers of recommendation algorithms and/or data for use in a system according to the present disclosure may wish to keep in mind that every data dimension may be evaluated and the best algorithm providing recommendations in each area may be selected during optimization. So to improve, the recommendation algorithms and/or data should supply recommendations specific to these contexts. This will cause a system in accordance with the present disclosure to select recommendations from the context instead of a general cache. A general cache may, for example, contain a set of recommendations that are not customer-specific. In accordance with certain aspects of the present disclosure, recommendations in the feed to the system of the present disclosure may be tagged, as specific to a context, which then overrides the recommendations from a general cache. For example, when a system according to the aspects of the present disclosure encounters a customer from an geographic area where there is presently bad weather, recommendations that are specific to that type of weather will likely outperform those that are not.

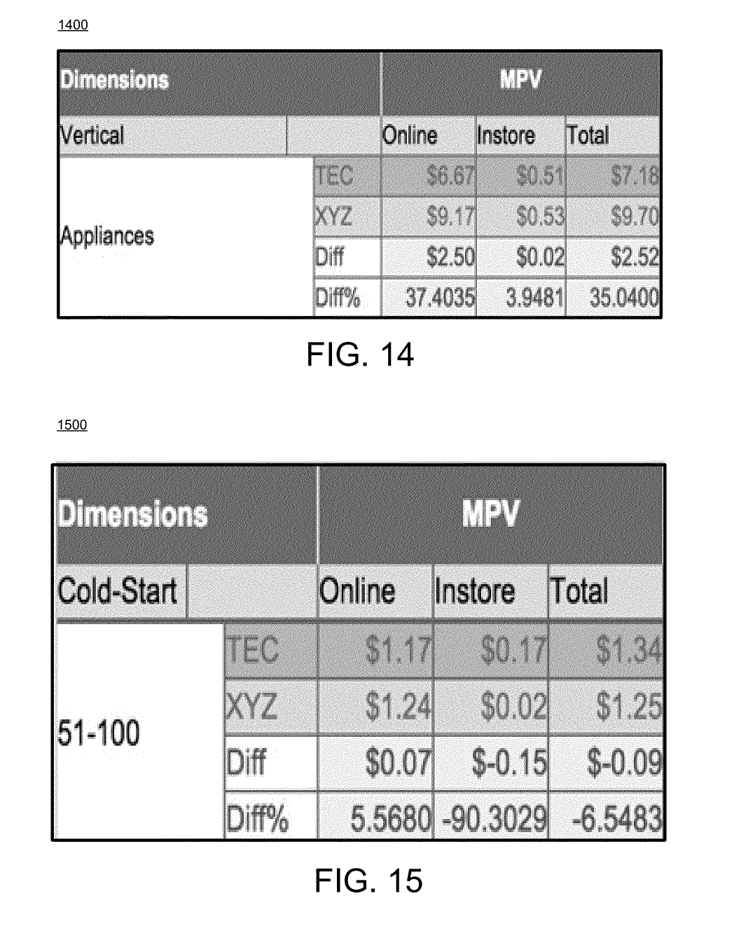

The following is a simplified example of how contextual optimization is computed, in a system in accordance with aspects of the present disclosure. This example considers only two dimensions (i.e., vertical and cold-start, with weights of 90 and 20) and only two recommendation algorithm participants (i.e., a control recommendation algorithm, labeled TEC, and a test recommendation algorithm, labeled XYZ). In the current example, we may assume that the current recommendation request is for a refrigerator that sold 83 units last year, so the data that a system of the present disclosure uses may correspond to the “Vertical” category of “Appliances”, shown in FIG. 14, and the “Cold-Start” bucket as “51-100,” shown in FIG. 15. The term “cold start” may be used herein to refer to a measure of how much data a merchant has about a product. For example, a “Cold-Start” bucket labeled “51-100” means that the system has accumulated metrics for between 51 and 100 sales of an item. In the present example, we will assume that we know that the customer has an online buying propensity. The system next finds the data dimension's “Profit PUM” and associated confidence measures.

FIG. 14 is a table showing “Profit PUM” for a “Vertical” category of “Appliances”, accordance with various aspects of the present disclosure. As evident in the example of FIG. 14, the “Profit PUM” for the “online” channel is shown as $6.67 for the control recommendation algorithm (i.e., “TEC”) and $9.17 for the test recommendation algorithm (i.e., XYZ).

FIG. 15 is a table showing “Profit PUM” for the “Cold-Start” case for a “51-100” bucket, in accordance with various aspects of the present disclosure. As shown in the illustration of FIG. 15, the “Profit PUM” for the “Cold-Start” bucket in the “online” channel is shown as $1.17 for the control recommendation algorithm (i.e., “TEC”), and is shown as $1.24 for the test recommendation algorithm under test (i.e., “XYZ”). Assume for this example that the “BoA” value (i.e., the probability of recommendation algorithm “XYZ” outperforming recommendation algorithm “TEC”) to be (TEC) 96% and (XYZ) 66% for Vertical “Appliances” and “Cold-Start” “51-100”. The system may then compute the following scores:

Score (Vertical as Appliances, Participant as TEC)=6.67*90*(96%−50%)*2=552.3

Score (Vertical as Appliances, Participant as XYZ)=9.17*90*(96%−50%)*2=759.3

Score (Cold-start as 51-100, Participant as TEC)=1.17*20*(66%−50%)*2=7.5

Score (Cold-start as 51-100, Participant as XYZ)=1.24*20*(66%−50%)*2=7.9

In this example, the system then computes the sum for recommendation algorithms “TEC” and “XYZ”, as follows:

Score (TEC)=552.3+7.5=559.8

Score (XYZ)=759.3+7.9=767.2

The scores indicate that recommendation algorithm “XYZ” is to be used in this customer context to supply recommendations (or customer traffic if the optimizations are being used to reduce the number of active versions).

Many of the currently defined “Dimensions”, such as “Trips”, “Weather”, and Cold-Start+Vertical are very similar to the example related to “Vertical” and “Cold-Start”, discussed above. Other “Dimensions” may be a little different in implementation from the example given above. For example, the “Dimension” for “Day-of-Week” may be used only when today is a particular customer's typical shopping day, or when the lead time from a recommendation yields a particular day of the week as the shopping day. This approach may look for differences in strategies that take days into consideration, like shopping on a weekend vs. shopping on a weekday, and may favor a certain recommendation technique.

In another example, a particular customer's “TasteRank” data may show that Monday has the highest score among the seven days in a week. In this situation, this “Dimension” may be used only if today is Monday. Monday's total “Profit PUM” and Monday's “In-store/Online Profit PUM” (e.g., based on this customer's “TasteRank” data) may also be computed separately and added together for this “Dimension”.

In yet another example, a particular customer's “TasteRank” data may show the average number of days after a major campaign (i.e., email) is received until the customer normally makes a purchase. This information may be used to determine the possible shopping date and the recommendation technique that delivers the best “Profit PUM” on that day.

In a system according to various aspects of the preset disclosure, selection of participants may also be based on the individual click scores at the product level. This information may be updated daily, and may allow the customer contexts overall to be updated based on uneven or changing

When a strategy is selected for a recommendation request, “CPV” and “Views” for the product may be examined. For example, when the number of views is larger than a certain amount (e.g., a certain percentage of the customer context's average), and “CPV” is smaller than a set amount (e.g., as compared against the customer context's average), the following steps may be executed. If the “CPV” of the customer's context is less than a certain number (e.g., the actual overall winning “CPV” in the “testing phase”), the chosen strategy may be switched. If the other strategy doesn't have more than a certain number n (e.g., 10) views on this input item, then the other strategy may be chosen. If the other strategy has more than n (e.g., 10) views on this input item, then the “CPV” for this input item from each of these strategies may be compared and the winner may be chosen. When the above-mentioned conditions are not met, the original chosen strategy generated from “contextual optimization” by a system according to aspects of the present disclosure may not be switched. If a switch of the original chosen strategy is made, the switch may be recorded and may be a source of information from which the recommendation provider may learn about their product-level performance, to enable further improvement. Also, the switch may be a source of information for the automatic learning process for use in updating the “contextual optimization”, discussed in further detail below.

In a system according to various aspects of the present disclosure finds that more than a certain amount, n (e.g., 1%), of the recommendations in a specific context are forced to switch the strategy due to the “Product Level Optimization”, then the system may adjust the confidence to be n % (e.g., 5%) less for the specific context.

This may, at some point, cause the context selection process to select a different context that was initially not as good. It should be noted that this approach assumes that all of the contexts are available for the runtime selection process, so that if one context gets too low to be selected, another context is still there. If the context is no longer available (e.g., no eligible strategies), the system may default to a higher level and may continue to adjust.

A system in accordance with various aspects of the present disclosure may employ a number of “Independent Measures” that are recorded directly, not derived. When comparing multiple strategies, the user of the system can use these measures to understand questions like whether one side has more customer traffic than the other side, and whether one side has more invalid recommendations, etc. The right part 930 of the test system detail web page 900 of FIG. 9 may display information for what may be referred to herein as “Independent Measures” identified as, for example, “UM”, which refers to a unique member or customer; “Sent”, which refers to the customer number that received recommendations; “Invalid”, which “Sent” didn't have a view; “Viewed”, which refers to the number of web pages opened; “TC”, which refers to the total number of customer clicks; and “UC”, which refers to unique clicks.

The right part 930 of the test system detail web page 900 of FIG. 9 may also display “Independent Measures” such as “Order Num”, which refers to the number of orders; “Abandon Cart Num”, which tracks when the “PSID” added an item to a cart and did not “check out”; “Revenue”, which refers to the total amount of money received (i.e., the total selling price); “Margin”, which refers to the total sales revenue minus the cost of goods sold; “Profit”, which refers to the surplus remaining after total costs are deducted from total revenue; “Redeemers”, which is a count of orders where there were any amount of loyalty program or reward points used; and “Visits”, which is the average number of visits a customer received the recommendation being tested. For example, if a customer interacted with the merchant on one day, three different times, the “Visits” value would be “3”. Each “Visit” means a different interaction session with the customer. The right part 930 of FIG. 9 may also include an “Independent Measure” referred to as “Trips”, which is the average number of days a customer received the recommendation being tested. For example, if a customer interacted with the merchant system on one day, three different times, it would be one “Trip”.

A system in accordance with various aspects of the present disclosure may also employ a number of “Per View Measures”. “Per View Measures” may be used (e.g., without doing “fill'in” for those measurements that have no valid returns), if a user of the system of the present disclosure would like to compare different recommendation algorithms, or if the user of the system of the present disclosure doesn't have a full strategy yet, but would like to have some initial measurements. Examples of “Per View Measures” include “Cony View”, which refers to conversions per “View”, where a “conversion” is a customer purchase; “RPV”, which refers to revenue per view; “MPV”, which refers to margin per view; “PPV”, which refers to profit per view; “TCPV”, which refers to total clicks per view “UCPV”, which refers to unique clicks per view; and “RedeemersPV”, which refers to redeemers per view.

A system in accordance with various aspects of the present disclosure may also employ a number of “Per Sent Measures”. In comparison with “Per View Measures”, “Per Sent Measures” may tell the user of a system according to the present disclosure more about the overall effectiveness, as the actual financial change may be based on all requests. When invalid ones are rare, “Per View Measures” and “Per Sent Measures” will be similar. Examples of “Per Sent Measures” include “Cony Sent”, which may refer to conversions per “Sent”; “InvalidRate”, which may refer to “Invalid” per “Sent”; “RPS”, which may refer to revenue per “Sent”; “MPS”, which may refer to margin per “Sent”; “PPS”, which may refer to profit per “Sent”; and “RedeemersPS”, which may refer to redeemers per “Sent”.

Similar to “Per View”, a system in accordance with various aspects of the present disclosure may also employ a number of “Per Unique Customer Measures”, also referred to herein as “Per Unique Member Measures”. Such measures focus on a customer as a whole, instead of on a number of “Views”. If the user of a system according to the present disclosure is comparing the same basic recommendation algorithm, but having some small change in formula, where the “Invalids” would naturally be about the same, the user may use this. This is the net effectiveness per customer when everything else is the same and no adjustments for Invalid” may be needed. Examples of “Per Unique Customer Measures” include “Cony UM”, which may refer to conversions per unique customer; “Rev PUM”, which may refer to revenue per unique customer; “Margin PUM”, which may refer to margin per unique customer; “Profit PUM”, which may refer to profit per unique customer; “Abandon PUM”, which may refer to abandoned cart number per unique customer; “Redeemers PUM”, which may refer to redeemers per unique customer, “Visits PUM”, which may refer to the percentage of “Trips”. That is, if there are 10 total “Trips” and 50 “Visits”, then the resulting “Visits PUM” measure is 20%. Finally, a “Trips PUM” measure may refer to a % of all days in a test. That is, if a test is 14 days long and the customer came three days during the test, the “Trips PUM” measure value is 3 out of 14.

A system in accordance with various aspects of the present disclosure may also employ a number of “Per Order Measures”, which may indicate how much each customer order is worth on average to the merchant. Examples of “Per Order Measures” include “AOP”, which may refer to average profit per customer order; “AMV”, which may refer to average margin per customer order; and “AOV”, which may refer to average revenue per customer order.

A system in accordance with various aspects of the present disclosure may also employ a number of “Per Invalid Measures”. Examples of “Per Invalid Measures” include “Cony Invalid”, which may refer to conversions per “Invalid”; “RPI”, which may refer to revenue per “Invalid”; “MPI”, which may refer to margin per “Invalid”; “PPI”, which may refer to profit per “Invalid”; and “Redeemers PI”, which may refer to redeemers per “Invalid”.

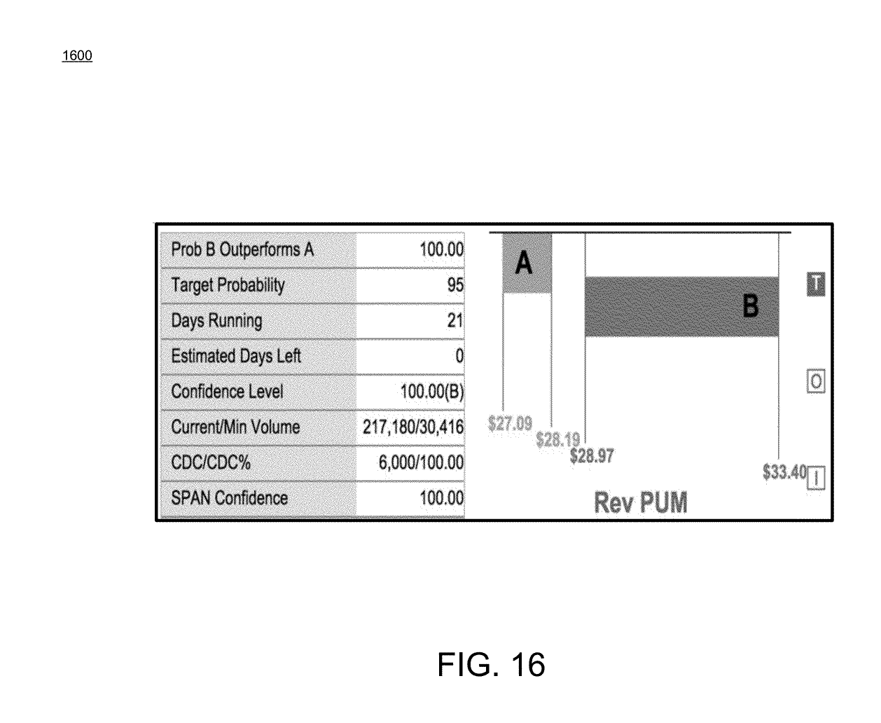

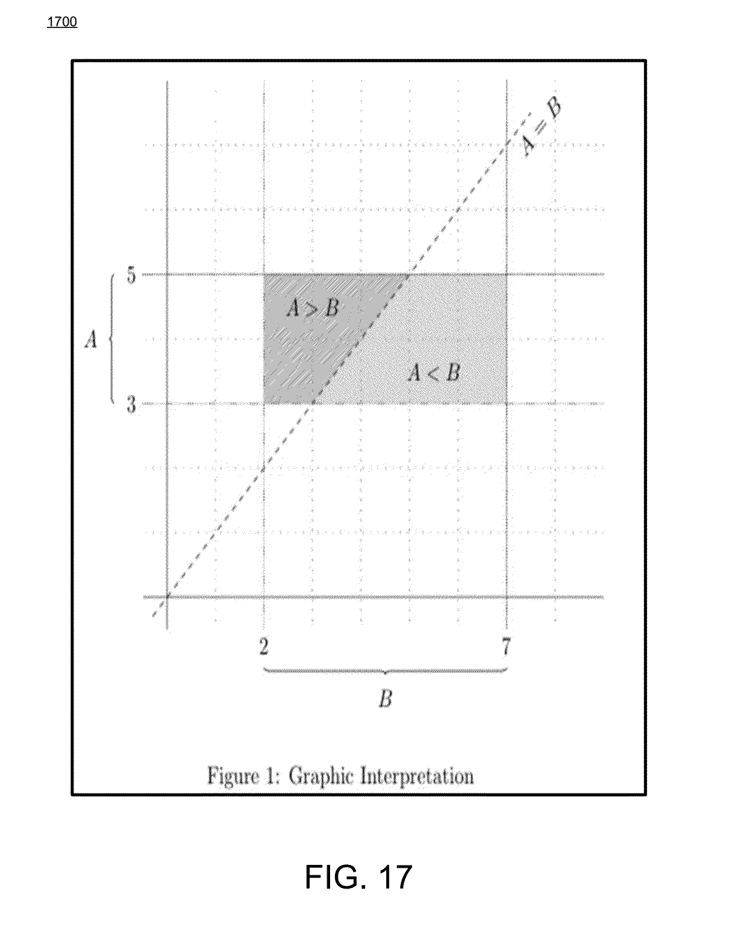

FIG. 16 is an illustration of confidence related measures that may appear in, for example, the middle portion 924 of FIG. 9, in accordance with various aspects of the present disclosure. In the illustration of FIG. 16, there are four confidence-related measures that may be used: “Prob B Outperforms A”, “Confidence Level”, “CDC”, and “SPAN Confidence”.

The “Prob[ability] B outperforms A” and “Estimated Days Left” values shown in FIG. 16, as well as the interval graph in the right-hand portion of FIG. 16 are from a first set of confidence-related measures. The “Prob[ability] B outperforms A” measure represents the likelihood that the “B”-side strategy will outperform the “A”-side strategy. A “Prob[ability] B outperforms A” value of 50(%) indicates that one side (e.g., the “A” side) is no better or worse than the other side (e.g., the “B” side), while values of 100(%) and 0(%) are two extremes. Although seemingly counterintuitive, a “Prob[ability] B outperforms A” value of 50% may be considered a baseline. As an example, the “Prob[ability] B outperforms A” measure of the present disclosure is similar to the knowledge that one has for the outcome of each trial of a process having two possible outcomes such as, for example, the flipping of a coin. The probability of occurrence of either outcome (i.e., “heads” or “tails”) of a trial (i.e., each flip of the coin) is expected to be 50%, if the coin is a normal coin and there are sufficient flips. While that knowledge may be the worst case situation when you are a gambler, the further away the observed value of “heads” versus “tails” is from 50% in a long-term trial, the better knowledge you have about the coin, and the more confident you may be to place a bet on which will come up on the next flip. The “Prob[ability] B outperforms A” measure is similar to this example.

A shown in FIG. 16, a methodology employed by a system in accordance with aspects of the present disclosure may use a “Target Probability” (i.e., a “Target Confidence” Level, which may default to 99%) as input, and intervals may be calculated through Bayesian updates of flat priors. A “Mellin Transform” may be used when multiplying two distributions to keep the interval length reasonable for comparison. The “Prob B Outperforms A” measure may then be derived based on the projection of two intervals onto the two axes of a two-dimensional plane. The “Estimated Days Left” measure may then be intuitively understood as how much the intervals should be shortened to get to the “Target Probability”/“Target Confidence” value.

The illustration of FIG. 16 also includes a “Confidence Level” and “Current/Min Volume” measure values that belong to a second set of confidence-related measures. The “Confidence Level” and “Current/Min Volume” measure values may be used to determine whether the two strategies being compared are statistically different, but may not be used to determine whether one strategy is better or worse than the other strategy. This methodology is based on traditional hypothesis testing where the confidence level is computed from the formula with the input of the current traffic volume. Then the Min Volume can be derived from the same formula with the input of 95% target confidence.

The illustration of FIG. 16 also includes a “CDC/CDC %” measure values that belong to a third set of confidence-related measures. The “CDC/CDC %” measure values may be used to determine whether testing has reached an arbitrary minimum fixed number of data points, which may default to, for example, 20,000 for each strategy. The “CDC/CDC %” measure values may be used as an indication that sufficient testing has been made, when the “A”-side and “B”-side strategies show no difference, indicating that the two strategies are performing evenly and that further testing is not likely to result in any better determination.

The “SPAN Confidence” measure value shown in FIG. 16 provides an overview that takes the sets of confidence-related measures discussed above into consideration, and tells the user of a system according to the present disclosure that there is (or conversely, is not) good agreement between all of the tests across different financial views.

A system in accordance with various aspects of the present disclosure provides several different ways (i.e., models) that enable the user to compare test strategies and results. The user of a system in accordance with aspects of the present disclosure may, for example, change the financial model using settings that appear on the center part 920 of the example test system detail web page 900 shown in FIG. 9. The default model ma, for example, be “Total Revenue By Test Life” for both the test system detail web page 900, and for reports accessible via the “A/B Dump and Report Screen 1200” illustrated in FIG. 12.

A system in accordance with various aspects of the present disclosure may support, for example, the following four models, which may be used to attribute the revenue based on certain events. A first of the models of this example may be referred to herein as “Revenue Attribution By Recommendation.” The “Revenue Attribution By Recommendation” model of the present disclosure may attach revenue to the nearest recommendation campaign/carousel. A second model of this example may be referred to herein as “Revenue Attribution By View”, which may attach revenue to the nearest recommendation campaign/carousel where the recommendations were actually displayed (e.g., email opened). A third model of this example may be referred to herein as “Revenue Attribution By Click”, which may attach revenue to the nearest recommendation campaign/carousel that was clicked in by the customer. A fourth model of this example may be referred to herein as “Revenue Attribution By Items Clicked In Order”, which may attach revenue based on the item recommended being the same or similar items purchased.

A system in accordance with various aspects of the present disclosure may also support, for example, the following models, which may be used to attribute the revenue based on a natural time frame (e.g., day or 30-day) and for all orders for the strategies. A first model of this example may be referred to herein as “Total Revenue By Day”, which may find all revenue (e.g., purchases or orders) that occurred on the same day as the recommendations for a specific customer. A second model of this example may be referred to herein as “Total Revenue By Test Life”, which may find all revenue (e.g., purchases or orders) for the entire date range of the test, for all the views within the test period that occurred before any order that was also within the entire date range of the test period.

A system in accordance with various aspects of the present disclosure may accumulate a number of additional data “Dimensions” that may be used as part of customer contextual behavior. A number of data “Dimensions” have been discussed above with respect to the left part 910 of the example test system detail web page 900 shown in FIG. 9. For example, data “Dimensions” that are illustrated or suggested above with respect to the left part 910 of the example test system detail web page 900 include “Cold-Start”, “Date”, “Day of Month”, “Day of Week”, “Month”, “Personalized” (i.e., vs not Personalized), “Recommendations”, “Source Breakdown”, “Trips”, “Region”, “Season”, “Weather”, and “Forecast”.

A number of additional data “Dimensions” are also contemplated including, for example, a dimension that may be referred to herein as “View but no Click”, which may record when a customer opens or views a carousel/campaign but does not click on the carousel/campaign; a dimension that may be referred to herein as “Traffic to Page but not Carousel”, which may record when a customer navigates to a web page with a carousel but does not click on the carousel because the carousel was under a fold or some other reason; and a dimension that may be referred to herein as “Carousel Requests with No Results”, which may record when a carousel had no recommendations. The above example dimensions may be variable, depending on the test.

In addition, a system according to various aspects of the present disclosure may support a dimension that may be referred to herein as “Day of Week”, which may be used to produce recommendations that will align best with customer propensity for purchases by day of week, and may record customer identity and the channel (e.g., in-store, online, etc.) used. The system may also support a dimension that may be referred to herein as “Content Breakdown”, which may record details for all sources of content including, for example, “Defaults”, “Tags-Driven”, “Browse-Driven”, “Search-Driven”, and “Rule-Driven”.

Additional dimensions include a dimension that may be referred to herein as “Marketing Segment Breakdown”, which may record details for all marketing segments including “Segment (rule/tag xxx)”, “Segment (rule/tag xxx with TEC rule yyy)”, “Segment-(rule/tag yyy with Default used)”, and “NoSegment-(TEC rule nnn)”, which may be referred to by other names such as “tags” or “nsegments. A dimension referred to herein as “Message Breakdown” may be used to record details for all customer-directed messages including, for example, “ ” and “Message-yyy”; and a dimension that may be referred to herein as “Offers/Discount Breakdown” may be used to record details for all customer-directed offers or discounts including, for example, “Offer-(ID)”, “Coupon-(ID)”, “Deal-(ID)”, and “Points-(ID)”.

Further dimensions may include, for example, a dimension that may be referred to herein as “Asset Thresholds”, which may record details for all areas that have thresholds being measured, where statistics are reported if they go outside the thresholds, and may include a “Threshold-(ID)”. These are presently able to be done in each asset. A dimension that may be referred to herein as “Orders Per Time” may include a number of “buckets” into which orders are grouped such as, for example, orders per customer in the last week, the last month, the last three months, the last six months, the last year, and during the customer “lifetime”, for visits that take place backwards in time from the indicated time period, and may be based on customer profile data. A dimension that may be referred to herein as “Visits Per Time” may include a number of “buckets” into which orders are grouped such as, for example, orders per customer in the last week, the last month, the last three months, the last six months, the last year, and during the customer “lifetime”, for orders that take place backwards in time from the indicated time period, and may be based on customer profile data.

In addition, a system according to various aspects of the present disclosure may include a data dimension that may be referred to herein as “Channel to Site”, which may record the way the customer got to the site including, for example, “Search Engine Organic”, “Search Engine Ad”, “Display Ad”, “Link in Email Promotion”, “Link in Triggered Email”, “Affiliate Shopping Engine”, “Direct-To-Site”, “Social”, ad “Other”. Another dimension that may be included may be referred to herein as “Channel to Page”, which may record the way a customer got to a specific product detail page (PDP) of the merchant web site, and may include, for example, “Search Engine Organic”, “Search Engine Ad”, “Display Ad”, “Link in Email Promotion”, “Link in Triggered Email”, “Affiliate Shopping Engine”, “Direct-To-Site”, “Click on Navigation Link”, “Internal Search”, “Recommendation (and sub-breakdown of the different types of recommendations)”, “Social”, and “Other”.

Additional data dimensions that may be supported by a system in accordance with various aspects of the present disclosure include “Page View Hierarchy”, which may record the taxonomy of the last few pages viewed by the customer in the current session (i.e., before the current page). This may be designed to show any trends that may be happening at the page level including, for example, a number of categories or taxonomies “Taxonomy 1”, “Taxonomy 2”, etc. A dimension that may be referred to herein as “Conversion Hierarchy” may record the taxonomy of the last few orders by the customer, and may be designed to show any trends that may be happening at the order level including “Taxonomy 1”, “Taxonomy 2”, etc. A further dimension that may be supported may be referred to herein as “Anonymous, Identified, Logged-In Customers”, which may record revenue and clicks, for web pages only, for customers who were identified in one of a number of buckets including, for example, “Anonymous”, “Identified”, and “Logged-In”. A dimension that may be referred to herein as “Personalized (vs Not Personalized) Recommendations” may record the color of a bucket computed for the customer from a number of different color buckets (e.g., white, yellow, red). Additional information about the concept of “colors” in relation to customers is discussed below.

A system in accordance with the present disclosure may support a data dimension that may be referred to herein as “New Online Customers”, which may record a customer making a first online purchase during this test, and a data dimension that may be referred to herein as “New Offline Customers”, which may record a customer making a first in-store purchase during this test. A data dimension referred to herein as “Merchant-Defined Recommendations” may record “Merchant Rule Portal” (MRP) mappings from merchants (or not), and when a recommendation is made, and if the recommendation was influenced by merchants in MRP, then the system tracks data based on this (or not). A data dimension referred to herein as “Merchant-Specials” may record MRP specials (or not) that may be attached to the recommendations as a tag when the recommendations are made. A data dimension that may be referred to as “LTV” may record a 10-bucket level of system-computed long-term-value (LTV) scores of customers, and may be recorded when an order is processed and attached to A/B test data, similar to the manner in which personalization colors are attached/assigned, and may be based on a customer profile LTV score.

Other data dimensions that may be supported by a system according to the present disclosure include, for example, a dimension referred to herein as “LTV Trend”, which may be recorded when an order is processed and attached to a test. This dimension may record an “Up”, “Down,” or “None” indication, and may be based on the customer profile LTV Trend score. A data dimension that may be referred to herein as “Micro-Segments”, may record when an order is processed and attached to a test. This dimension may be based on a customer profile micro-segment identifier (ID), and may include an indication of the source (e.g., “TEC”, “DLS”, etc.) of the segment and the individual identifier (ID).

An additional data dimension that may be supported by a system according to the present disclosure may be referred to as “TasteRank”, which may be recorded when the order is processed and attached to the test, and may be from a customer profile TasteRank scores. Example aspects of “TasteRank” include, for example, “Category” (e.g., “Hardlines” vs “Softlines”); “Price 1”, which may record a first price (e.g., using a first method of looking at low vs. high priced items); “Price 2” which may record a second price (e.g., using a second method of looking at low vs. high priced items); “Quality”, which may record customer preference of low vs high quality item purchases; “Unrated Quality”, which may record that a customer will or will not purchase items not star-rated by others; and “Brand”, which may record that a customer has no brand loyalty vs. a strong brand loyalty. Further aspects of “TasteRank” include, for example, “Personalized”, which may record a low or high level response to personalized recommendations; a “Channel”, which may record whether the customer shops mostly in-store or online; a “Days after Campaign”, which may record when a customer purchase/order is received relative to a campaign. This aspect may be attached to a campaign, and may represent an average of the days from a campaign to a customer purchase/order such as, for example, 0=no rating, 1=within 1 day, 2=within 2 days, . . . , 5=more than 4 days. An additional aspects of “TasteRank” may be referred to herein as “Day of Week”, which may record the day of the week that a customer usually makes purchases such as, for example, 0=no data, or a rating values of 1 to 5, for each of Sunday through Saturday.

Additional dimensions may be supported by a system according to the present disclosure including, for example, “Gender-Person Ratings”, which may be recorded when a purchase/order is processed and attached to a test, and may be based on a customer profile Gender/Person score; a “Device Type” dimension, which may record the type of device used by a customer during an interaction with the merchant such as, for example, a “PC/laptop”, a “Tablet”, and a “Phone”, etc. A data dimension that may be referred to herein as “Recommendation Granularity” may be supported by the system of the present disclosure. Recommendations for a customer may, for example, be computed at a low level of granularity based on, for example, many factors including specific interests, preferences, contexts, etc. The recommendation selected for delivery to the customer may, however, be generalized, if determined by the system or the merchant. The data dimension “Recommendation Granularity” may record that a recommendation made for a particular cordless drill is to be returned for “Product” (i.e., recommendations are returned at the product level), “Sub-Category” (i.e., recommendations are returned at the taxonomy sub-cat level), “Category” (i.e., recommendations are returned at the taxonomy category level), or “Vertical” (i.e., recommendations are returned at the taxonomy vertical level) levels, in order to point the customer to a less-specific web page, if desired.

A system in accordance with the present disclosure may support a data dimension referred to herein as “Customer-Interest Ratings”, which may be recorded when the order is processed and attached to the test. Such a data dimension may be based on customer profile scores, and may indicate a “Subjects” aspect that computes bundles based on subject interests, an “Activities” aspect that computes bundles based on activity interests, and a “Predict 1” aspect that may use what may be referred to as “setpatterns” to find similar customer interests that purchase in these setpatterns, may look for other setpatterns that these customers purchase in, may find the difference of which of these customers did not purchase from these common setpatterns, which may then be used as a setpattern to recommend. The term “setpattern” may be used herein to refer to an abstraction of a product to its base content. For example, a product may have a lengthy title and description and attributes, but from in an abstraction it may be represented by its significant topics such as, for example, refrigerator+top+freezer+<manufacturer name>. Such recommendations may be limited to a month and a geographic location (e.g., a state).

A “Predict-2” aspect may cause the system of the present disclosure to record the location of common purchases by, for example, a 3-digit zip-code for specific sub-categories, may find customers in that zip-code who did not purchase a product from that subcategory, and may then recommend that product. A “Predict-4” aspect may be used to compute and record, for each vertical, a big or small discount probability per sub category. A “Predict-5” aspect may be used to compute personalized recommendations to individual customers in a collaborative filtering fashion taking the purchase history, zip codes and time of purchase information into account. A “Target” aspect may use setpatterns to find similar customer interests that purchase in these setpatterns, and the system may then look for other setpatterns that these customers purchase in, and then find the diff of which of these customers did not purchase from these common setpatterns. The system may then recommend that setpattern to the customer.

A system in accordance with the present disclosure may support a data dimension referred to herein as “Micro-Segment Interest Ratings”, which may be recorded when an order is processed and may be attached to a test. It should be noted that this rating may be based on customer profile micro-segment interests, and that aspects may relate to “Subjects”, in which the system may compute bundles based on subject interests, “Activities”, for which the system may compute bundles based on activity interests. A “Predict 1” indication may cause the system to use what may be referred to herein as “setpatterns” to find similar customer interests that purchase in these setpatterns, may then look for other setpatterns that those customers purchase in, and may then find the difference of which of these customers did not purchase from these common setpatterns. The system may use that as a setpattern to recommend. The system may limit recommendations to a month and a geographic region (e.g., a state). A “Predict 2” indication may cause a system according to the present disclosure to locate common purchases by 3-digit zip-code for specific subcategories, and then find customers in that zip-code who did not purchase something from that subcategory and recommends one of those common purchases. A “Predict-4” indication may cause a system of the present disclosure to compute for each “vertical”, the big or small discount probability per sub-category. A “Predict-5” indication may cause a system according to the present disclosure to compute personalized recommendations to individual customers in a collaborative filtering fashion taking the purchase history, zip codes, and time of purchase information into account. A “Target” indication may cause a system according to the present disclosure to use “setpatterns” to find similar customer interests that purchase in these setpatterns, look for other setpatterns that these customers purchase in, and then find the difference of which of these customers did not purchase from these common setpatterns. That setpattern may then be used to make a recommendation to the customer.

A system in accordance with the present disclosure may support a data dimension that may be referred to as “Intent Browse Ratings”, which may show the intent ratings from any browses that occurred during the test period. Indications of “Good-Sale”. “Bad-Sale”, and “Unknown” may be provided. A system in accordance with the present disclosure may also support a data dimension that may be referred to as “Intent Interaction Ratings”, which may show the intent ratings from interactions that occurred during the test period. Indications of “Good-Sale”, “Bad-Sale”, and “Unknown” may be provided. In addition, a system in accordance with the present disclosure may support a data dimension that may be referred to as “Cold-Start”, which may show sales (e.g., per year) of items by volume groups to show how recommendations work in “Cold-Start”. Indications of “0-10”, “11-25”, “26-50”, “51-100”, “101-500”, “501-1000”, “1001-5000”, and “5000+” may be provided.

A system in accordance with the present disclosure may support a data dimension that may be referred to as “Returns, Cancels & Abandons”, which may show orders and dollars. Indications of “Returns”, “Cancels”, and “Abandon Carts” may be provided. A system in accordance with the present disclosure may also support a data dimension that may be referred to as “Shipping Breakdown”, which may show details for all types of online shipping methods. Indications of “Regular”, “Free”, “Type1”, and “Type2” may be provided. In addition, a system in accordance with the present disclosure may support a data dimension that may be referred to as “Online Breakdown”, which may show details for all types of online orders. Indications of “.COM”, “Mobile”, and “SYW” may be provided.

A system in accordance with the present disclosure may support a data dimension that may be referred to as “Source Breakdown”, which may show details for all types of online orders. Indications of “Merchant 1 (e.g., Sears), “Merchant 2 (e.g., Kmart), and “Marketplace” may be provided. A system in accordance with the present disclosure may also support a data dimension that may be referred to as “Weather”, which may show a weather code for each day for each zip for each customer. For example, up to ten weather-code “buckets” may be supported, with corresponding orders and dollars. In addition, a system in accordance with the present disclosure may support a data dimension that may be referred to as “Weather Forecast”, which may show a 5-day weather forecast.

A system in accordance with the present disclosure may support a data dimension that may be referred to as “Region”, which may show regions of the US based on customer location. A system in accordance with the present disclosure may support a data dimension that may be referred to as “Zip Code”, which may show zip codes of the U.S. A system in accordance with the present disclosure may support a data dimension that may be referred to as “Month′”. A system in accordance with the present disclosure may support a data dimension that may be referred to as “Time of Day”, which may show the different hours of the day and how financial performance did in those hours. This data dimension may be used to determine when a customer typically shops (e.g., hour of day), what kinds of customers are shopping, and for what kinds of products.

A system in accordance with the present disclosure may support a data dimension that may be referred to as “Event”, which may show holidays or seasonal events. Indications of “Returns”, “Cancels”, and “Abandon Carts may be provided. A system in accordance with the present disclosure may also support a data dimension that may be referred to as “Bundles”, which may show that an input item has bundle computations. An indication may be attached to a recommendation as a “tag” when the recommendations are made. The “tag” may show the different type of bundles such as, for example, “Regular”, “Next”, etc. and also may indicate a type such as, for example, “Purchases”, “Interests”, “Target”, “Predict-1”, “Subjects”, “Activities”, etc., and may be based on a customer profile.

A system in accordance with the present disclosure may support a data dimension that may be referred to as “Churn”, which may use, for example, ten buckets to measure the collective probability scores of customers not making more purchases. “Tags” may be placed on customers showing probabilities of their making more purchases, which may be compared against various strategies to show what works best to keep the customer purchasing. This data dimension may be based on a customer profile. A system in accordance with the present disclosure may also support a data dimension that may be referred to as “Inactive”, which may, for example, be a binary True/False indicator that these customers are likely now inactive and should be interacted with, using appropriate “win-back” techniques. Various strategies may be used and measured to determine what approach is most effective in getting dead customers back. This data dimension may be based on a customer profile.

A system in accordance with the present disclosure may support a data dimension that may be referred to as “Email Interaction Frequency”, which may use, for example, ten buckets to measure customer performance based on computed days recommended between interactions. Customers may be “tagged” with probabilities on how many “wait-days” until a customer is contacted with a promotional email again. Various strategies may be used to measure the effectiveness and how to reduce the number of days by using various combinations of interactions. This data dimension may be based on a customer profile.

A system in accordance with the present disclosure may support a data dimension that may be referred to as “Brand Price Points”, and which may use, for example, ten buckets to measure customer performance based on price points to expected brands, which may be price ranges for brands that each customer would be most likely to purchase. This data dimension may be based on customer profiles. A system in accordance with the present disclosure may also support a data dimension that may be referred to as “Brand Preference”, which may use, for example, ten buckets to measure customer performance when predicted brand preferences are used, which may represent brands that should be recommended to the customer, and the level of interest that the customer likely has in that brand. This data dimension may be based on customer profiles.

A system in accordance with the present disclosure may support a data dimension that may be referred to as “Sentiment Rating”, which may show each of the sentiment ratings, with accumulations from each of the products purchased and another set for products recommended. A system in accordance with the present disclosure may also support a data dimension that may be referred to as “Redemptions”, which may use, for example, eleven buckets (e.g., 0 to 9 and 10+) to measure the number of redemptions used by the customer per year. This data dimension may be from the customer profile. In addition, a system in accordance with the present disclosure may support a data dimension that may be referred to as “Trips”, which may use, for example, eleven buckets (e.g., from 0 to 9 and 10+) that count the customers trips for the last year. This number may be present in the “Measures” screen of FIG. 10.

A system in accordance with the present disclosure may support a data dimension that may be referred to as “Basket Size”, which may record the size of each order based on a set of divisions such as, for example, “<$0.01”, “$0.01-$10” (in $10 increments to $100), 1100.01-$125″ (in $25 increments to $200), “$200.01-$250” (in $50 increments to $500), and “>$500”. A system in accordance with the present disclosure may also support a data dimension that may be referred to as “Merchant Customer Since”, which may record, for example, the amount of time since the customer began a relationship with the merchant, or joined a loyalty program operated by the merchant, and may be define by a set of time periods such as, for example, “<1 week”, “1 week to 1 month”, “1-3 months”, “3-6 months”, “6 months to 1 year”, and “Over 1 year”.

A system in accordance with the present disclosure may support a data dimension that may be referred to as “Activation”, which may record the amount of time since the customer last purchased, and may be define by a set of time periods such as, for example, “Shopped in the last week”, “Has not shopped in the last 1 month”, “Has not shopped in the last 2 months”, “Has not shopped in the last 3 months”, “Has not shopped in the last 4 months”, “Has not shopped in the last 5 months”, “Has not shopped in the last 6 months”, “Has not shopped in the last 1 year”, and “Has not shopped in the last 2 years”.

A system in accordance with the present disclosure may support a data dimension that may be referred to as “Operating System”, which may record an identifier of the operating system (OS) used by the electronic device used by the customer to interact with the online presence of the merchant such as, for example, “Android”, “iOS”, “Windows”, “Chrome OS”, “Linux”, “BlackBerry”, and “Other”. A system in accordance with the present disclosure may also support a data dimension that may be referred to as “Browser”, which may record an identifier of the Internet browser program used on the electronic device used by the customer to interact with the online presence of the merchant such as, for example, “Chrome”, “Safari”, “Internet Explorer (IE)”, “Android Browser”, “Firefox”, “Opera”, and “Other”.

A system in accordance with the present disclosure may support a data dimension that may be referred to as “Item Curation”, which may record individual crowd-sourced item recommendations so that small quantities can still be visualized and optimized.

A system according to various aspects of the present disclosure may use the following basic formula for a 2-sample t-test for significance testing with revenue.

$$t = \frac{{x}_{a hat} - {x}_{b hat}}{{σ}_{diff}}$$

where

$${σ}_{diff} = \sqrt{\frac{{S}_{a}^{2}}{{N}_{a}} + \frac{{S}_{b}^{2}}{{N}_{b}}}$$

In the formula for t, above, Xₐ_{_}ₕₐₜ is the average of revenues during the A/B test period for A. Let us say we have Nₐ users and we generate a total revenue Rₐ. The formula:

Xₐ_{_}ₕₐₜ=Rₐ/Nₐ

may represent the revenue per visitor including users with no purchase. The value of X_{b}_{_}ₕₐₜ may be computed in a similar fashion. Variables Sₐ and S_{b} are the standard deviations for samples A and B.

The P-value may then be computed as:

2*(1−tdist(t,df)).

where tdist is the cumulative distribution function for t-distribution.

For example, for calculating the P-value, we can use the function “pt” in R as:

2*(1−pt(t,df)),

where df is the degrees of freedom for the t-dist, computed as shown below:

$$df = \frac{{( \frac{{S}_{a}^{2}}{{N}_{a}} + \frac{{S}_{b}^{2}}{{N}_{b}} )}^{2}}{\frac{{( \frac{{S}_{a}^{2}}{{N}_{a}} )}^{2}}{{N}_{a} - 1} + \frac{{( \frac{{S}_{b}^{2}}{{N}_{b}} )}^{2}}{{N}_{b} - 1}}$$

If the P-value<alpha (chosen value), we may conclude that the differences are real and not occurring by chance.

We may also calculate the confidence interval around the difference in means between A and B. The N % confidence interval around the difference is calculated as follows:

(Xₐ_{ₕₐₜ}−X_{b}_{ₕₐₜ})±tₐ×σ_{diff}

where tₐ critical value from the t-distribution with the given confidence value and the degrees of freedom.

For example, we can calculate tₐ using the function “qt” in R as:

qt(1-alpha/2,df),

where alpha for 95% confidence is 0.05.

FIG. 17 is an illustration to aid in understanding an example calculation of the “Probability B Outperforms A” measure, in accordance with various aspects of the present disclosure. Initially we assume two intervals describing the performance of two versions in the context of an A/B test, say A=[3,5] and B=[2,7]. These could be, for example, the average revenue or profit per unique user, or the average number of page views in a session, or any other numeric metric of interest—calculated at some desired confidence level.

In the illustration of FIG. 17, the two intervals (i.e., [3,5] and [2,7]) are projected onto the axis, defining the shaded rectangle of FIG. 17, which represents all possible combinations for the performance of the two versions (at the desired confidence level). The area contained in this rectangle above the 45 degrees line, the slightly darker shade in the figure, represents those possible states of affairs where version “A” performs better than version “B”; similarly, the area below that line, the lighter shade, are those states of affairs where version “B” outperforms version “A”. The ratio between those two areas may thus be taken as an approximation for the probability of one version outperforming the other. In this example, 40% of the rectangle is above the 45 degrees line, or in other words there is an approximately 60% chance that version “B” outperforms version “A”.

A representative embodiment of the present disclosure leverages a number of available algorithms for identifying products or services most likely to be of interest to a consumer by selecting from the available algorithms an algorithm found to provide the most relevant, accurate, and timely information in a particular personal context.

A representative embodiment of the present disclosure allows many participants (i.e., a crowd) to submit or provide algorithms, methods, formulas and/or recommendation and personalization data, by any method desired. A system such as the host system 68 of FIG. 1 may be used to collect or access such submissions, to test the submissions, and to incorporate the use of such submissions into a system used to produce personalized recommendations for use in interacting with consumers, based on the performance of the various algorithms, methods, formulas, and recommendation personalization data, in specific personal contexts of the consumer. In some representative embodiments of the present disclosure, the submitter or provider of each algorithm, method, formula, or recommendation and personalization data that is used by the operator of the system may, for example, be compensated based on the use of their submitted algorithm, method, formula, and recommendation or personalization data such as, for example, any profit that may be realized by a merchant sponsoring or operating the system. In this manner, some representative embodiment of the present disclosure may encourage participation by many submitters with many different algorithms, methods, formulas, and/or recommendation and personalization data.

The applicant has found that recommendations and personalization are extremely difficult to optimize using prior art techniques, and that significant revenue and/or profit may be unrealized using “average” characteristics of demographic groups. In a representative embodiment of the present disclosure, the selection of recommendation techniques, algorithms, methods, or formulas based on personal contextual information helps to realize most if not all of the potential revenue for a merchant. A representative embodiment of the present disclosure makes use of the largest number of techniques, algorithms, method, or formulas as possible (i.e., crowdsourcing) and employs automated techniques for selecting the best performing techniques, algorithms, method, or formulas for producing recommendations and personalization using the personal contextual information of each specific consumer.

In a representative embodiment of the present disclosure, recommendation and personalization of advertisements, and correspondence, and web page content to a consumer may be performed in real-time based upon the current personal contextual information of the consumer, as described above. Such personal contextual information may be updated continually based on the activities of the consumer

A representative embodiment may use artificial intelligence, computer learning, and/or emergent data processing techniques to select one or more recommendation algorithms determined to generate personal recommendation information for a particular consumer that is contextually optimized, based upon personal contextual information for that consumer.

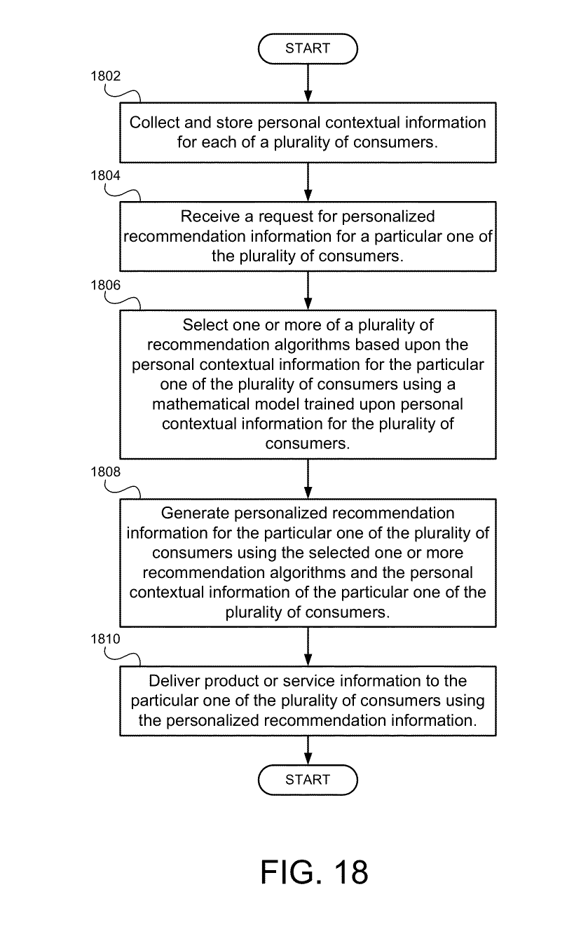

FIG. 18 is a flowchart of an exemplary method for providing personalized recommendations or promotional information to consumers based upon a recommendation algorithm (all or part) selected from a number of recommendation algorithms, by matching personal contextual information of each consumer to detailed contexts in which each recommendation algorithm exhibits optimal performance in some context, in accordance with a representative embodiment of the present disclosure. The actions of the method of FIG. 18 may, for example, be performed by one or more elements of a computer network such as, for example, the computer network 100 of FIG. 1.

The method of FIG. 18 begins at block 1802, where a system such as, for example, the host system 68 of FIG. 1, may collect and store personal contextual information for each of a plurality of consumers. Such personal contextual information may be the results of the various life and consumer activities, as described above. Next, at block 1804, a system performing the method may receive a request for personalized recommendation information for a particular one of the plurality of consumers.

At block 1806, the method may cause the system to select one or more recommendation algorithms from a plurality of recommendation algorithms, based upon the personal contextual information for the particular consumer of the plurality of consumers, using a mathematical model based upon personal contextual information for the plurality of consumers and the specific, detailed, context in which each of the plurality of recommendation algorithms exhibit optimal performance. In a representative embodiment of the present disclosure, the phrase “optimal performance” may be used to refer to an optimal outcome in terms of financial or other goals of a merchant or business.

At block 1808, the system may generate personalized recommendation information for the particular one of the plurality of consumers using the selected one or more recommendation algorithms and the personal contextual information of the particular one of the plurality of consumers. The generation of a personalized recommendation may, for example, comprise the selection of one or more products using the selected recommendation algorithm and the personal contextual information of the consumer, and the personalization of a web-based user interface for the consumer. The web-based user interface may be personalized by generating digital information representative of portions of a web page for transmission, via a communication network such as, for example, the Internet, to an electronic device of the customer having suitable hardware and/or software to display the personalized recommendation to the consumer.

Finally, at block 1810, the system performing the method of FIG. 18 may deliver product or service information to the electronic device of the particular consumer of the plurality of consumers using the personalized recommendation information.

Aspects of the present disclosure may be seen in a method of operating a system for providing personalized recommendations or promotional information to a plurality of consumers via an online interface of a merchant. Such a method may comprising providing a plurality of different personalization systems, wherein each personalization system produces respective personalization information for dynamically personalizing product information displayed to a consumer via the merchant online interface, based upon current personal contextual information of the consumer. The method may also comprise determining a respective effect upon the merchant of a consumer action responsive to a web page generated according to personalization information produced by each of the plurality of personalization systems, based upon personal contextual information of a plurality of consumers, and detecting a current action of a particular consumer of the plurality of consumers with respect to a first web page transmitted to the particular consumer via the online interface of the merchant. The method may further comprise adjusting the personal contextual information of the particular consumer to reflect the current action of the particular consumer with respect to the first web page, and selecting one personalization system from the plurality of personalization systems, according to the personal contextual information of the particular consumer and the respective effects of each of the plurality of personalization systems. Such a method may also comprise producing personalization information for the particular consumer, using the selected personalization system and the adjusted personal contextual information of the particular consumer; generating a second web page personalized for the particular consumer, using the personalization information produced by the selected personalization system; and transmitting the second web page to the particular consumer via the online interface of the merchant.

In various aspects of the present disclosure, each personalization system may comprise an algorithm that operates upon the personal contextual information of a consumer to identify one or more products to be advertised on a personalized web page for the consumer, and the respective effect upon the merchant may comprise an increase in profit. The method may further comprise computing an amount of compensation to a provider of the selected personalization system, according to the respective effect upon the merchant, and the current action of the particular consumer of the plurality of consumers with respect to the first web page may comprise selecting an advertised product for purchase. Generating the second web page for the particular consumer may comprise populating one or more user interface elements of the second web page with product information according to the personalization information, and the online interface of the merchant may be accessible via the Internet.

Additional aspects of the present disclosure may be found in a system for providing personalized recommendations or promotional information to a plurality of consumers via an online interface of a merchant. Such a system may comprising at least one processor configured with memory to support operation of a plurality of different personalization systems and to communicate via a packet network with a plurality of communication devices of a plurality of consumers, where each personalization system produces respective personalization information for dynamically personalizing product information displayed to a consumer via the merchant online interface, based upon current personal contextual information of the consumer. The at least one processor of such a system may be operable to, at least, perform the actions of the method described above.

Further aspects of the present disclosure may be observed in a non-transitory computer-readable medium comprising executable instructions for causing at least one processor to perform the steps of a method of operating a system providing personalized recommendations or promotional information to a plurality of consumers via an online interface of a merchant, as described above.

Although devices, methods, and systems according to the present disclosure may have been described in connection with a preferred embodiment, it is not intended to be limited to the specific form set forth herein, but on the contrary, it is intended to cover such alternative, modifications, and equivalents, as can be reasonably included within the scope of the disclosure as defined by this disclosure and appended diagrams.

Accordingly, embodiments in accordance with the present disclosure may be realized in hardware, software, or a combination of hardware and software. Embodiments in accordance with the present disclosure may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Embodiments of the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method of operating a system for providing personalized recommendations or promotional information to a plurality of consumers via an online interface of a merchant, the method comprising:
providing a plurality of different personalization systems, wherein each personalization system produces respective personalization information for dynamically personalizing product information displayed to a consumer via the merchant online interface, based upon current personal contextual information of the consumer;
determining a respective effect upon the merchant of a consumer action responsive to a web page generated according to personalization information produced by each of the plurality of personalization systems, based upon personal contextual information of a plurality of consumers;
detecting a current action of a particular consumer of the plurality of consumers with respect to a first web page transmitted to the particular consumer via the online interface of the merchant;
adjusting the personal contextual information of the particular consumer to reflect the current action of the particular consumer with respect to the first web page;
selecting one personalization system from the plurality of personalization systems, according to the personal contextual information of the particular consumer and the respective effects of each of the plurality of personalization systems;
producing personalization information for the particular consumer, using the selected personalization system and the adjusted personal contextual information of the particular consumer;
generating a second web page personalized for the particular consumer, using the personalization information produced by the selected personalization system; and
transmitting the second web page to the particular consumer via the online interface of the merchant.

2. The method according to claim 1, wherein each personalization system comprises an algorithm that operates upon the personal contextual information of a consumer to identify one or more products to be advertised on a personalized web page for the consumer.

3. The method according to claim 1, wherein the respective effect upon the merchant comprises an increase in profit.

4. The method according to claim 3, further comprising:
computing an amount of compensation to a provider of the selected personalization system, according to the respective effect upon the merchant.

5. The method according to claim 1, wherein the current action of the particular consumer of the plurality of consumers with respect to the first web page comprises selecting an advertised product for purchase.

6. The method according to claim 1, wherein generating the second web page for the particular consumer comprises populating one or more user interface elements of the second web page with product information according to the personalization information.

7. The method according to claim 1, wherein the online interface of the merchant is accessible via the Internet.

8. A system for providing personalized recommendations or promotional information to a plurality of consumers via an online interface of a merchant, the system comprising:
at least one processor configured with memory to support operation of a plurality of different personalization systems and to communicate via a packet network with a plurality of communication devices of a plurality of consumers, wherein each personalization system produces respective personalization information for dynamically personalizing product information displayed to a consumer via the merchant online interface, based upon current personal contextual information of the consumer, the at least one processor operable to, at least:
determine a respective effect upon the merchant of a consumer action responsive to a web page generated according to personalization information produced by each of the plurality of personalization systems, based upon personal contextual information of a plurality of consumers;
detect a current action of a particular consumer of the plurality of consumers with respect to a first web page transmitted to the particular consumer via the online interface of the merchant;
adjust the personal contextual information of the particular consumer to reflect the current action of the particular consumer with respect to the first web page;
select one personalization system from the plurality of personalization systems, according to the personal contextual information of the particular consumer and the respective effects of each of the plurality of personalization systems;
produce personalization information for the particular consumer, using the selected personalization system and the adjusted personal contextual information of the particular consumer;
generate a second web page personalized for the particular consumer, using the personalization information produced by the selected personalization system; and
transmit the second web page to the particular consumer via the online interface of the merchant.

9. The system according to claim 8, wherein each personalization system comprises an algorithm that operates upon the personal contextual information of a consumer to identify one or more products to be advertised on a personalized web page for the consumer.

10. The system according to claim 8, wherein the respective effect upon the merchant comprises an increase in profit.

11. The system according to claim 10, the at least one processor further operable to, at least:
compute an amount of financial compensation to a provider of the selected personalization system, according to the respective effect upon the merchant.

12. The system according to claim 8, wherein the current action of the particular consumer of the plurality of consumers with respect to the first web page comprises selecting an advertised product for purchase.

13. The system according to claim 8, wherein generating the second web page for the particular consumer comprises populating one or more user interface elements of the second web page with product information according to the personalization information.

14. The system according to claim 8, wherein the online interface of the merchant is accessible via the Internet.

15. A non-transitory computer-readable medium comprising executable instructions for causing at least one processor to perform the steps of a method of operating a system providing personalized recommendations or promotional information to a plurality of consumers via an online interface of a merchant, the at least one processor configured with memory to support operation of a plurality of different personalization systems and to communicate via a packet network with a plurality of communication devices of a plurality of consumers, wherein each personalization system produces respective personalization information for dynamically personalizing product information displayed to a consumer via the merchant online interface, based upon current personal contextual information of the consumer, the steps comprising:
determining a respective effect upon the merchant of a consumer action responsive to a web page generated according to personalization information produced by each of the plurality of personalization systems, based upon personal contextual information of a plurality of consumers;
detecting a current action of a particular consumer of the plurality of consumers with respect to a first web page transmitted to the particular consumer via the online interface of the merchant;
adjusting the personal contextual information of the particular consumer to reflect the current action of the particular consumer with respect to the first web page;
selecting one personalization system from the plurality of personalization systems, according to the personal contextual information of the particular consumer and the respective effects of each of the plurality of personalization systems;
producing personalization information for the particular consumer, using the selected personalization system and the adjusted personal contextual information of the particular consumer;
generating a second web page personalized for the particular consumer, using the personalization information produced by the selected personalization system; and
transmitting the second web page to the particular consumer via the online interface of the merchant.

16. The non-transitory computer-readable medium according to claim 15, wherein each personalization system comprises an algorithm that operates upon the personal contextual information of a consumer to identify one or more products to be advertised on a personalized web page for the consumer.

17. The non-transitory computer-readable medium according to claim 1, wherein the respective effect upon the merchant comprises an increase in profit.

18. The non-transitory computer-readable medium according to claim 3, the steps further comprising:
computing an amount of compensation to a provider of the selected personalization system, according to the respective effect upon the merchant.

19. The non-transitory computer-readable medium according to claim 15, wherein the current action of the particular consumer of the plurality of consumers with respect to the first web page comprises selecting an advertised product for purchase.

20. The non-transitory computer-readable medium according to claim 15, wherein generating the second web page for the particular consumer comprises populating one or more user interface elements of the second web page with product information according to the personalization information.

21. The non-transitory computer-readable medium according to claim 15, wherein the online interface of the merchant is accessible via the Internet.
